(19) United States
(12) Patent Application Publication
(10) Pub. No.: US 2026/0342812 A1
(43) Pub. Date: Oct. 29, 2026

(54) SYSTEMS AND METHODS FOR IMPLEMENTING CONTROL HUB ORCHESTRATION LAYERS FOR MONITORING

(71) Applicant: Capital One Services, LLC, McLean, VA (US)

(72) Inventors: Amber L. Morgan, McLean, VA (US); Tiffany D. Parashar, McLean, VA (US)

(73) Assignee: Capital One Services, LLC, McLean, VA (US)

(21) Appl. No.: 19/192,278

(22) Filed: Apr. 28, 2025

(51) Int. Cl. H04L 9/40; G06Q 20/40; H04L 43/045; H04L 43/08

(52) U.S. Cl. CPC H04L 63/1416; G06Q 20/4016; H04L 43/045; H04L 43/08

(57) ABSTRACT

Systems and methods are described for improvements to executing controls and monitoring numerous processes, workflows, and functions. As one example, systems and methods for a control hub orchestration layer and a control hub component layer. The control hub orchestration layer provides improve control execution, while the control hub component layer provides for improved monitoring of processes, workflows, and functions subject to a control.

### BACKGROUND

Computer networks execute numerous processes, workflows, and functions across different devices by leveraging a combination of hardware, software, and protocols that enable seamless communication and coordination. At the core of network operations are servers, routers, switches, and end-user devices that interact through well-defined networking protocols, such as TCP/IP, HTTP, and FTP. These networks utilize distributed computing, where multiple devices work together to handle tasks efficiently, ensuring that applications function smoothly. Load balancing mechanisms distribute workloads across multiple servers to prevent congestion and enhance performance, while cloud computing further extends computational capabilities by providing on-demand access to resources. Network management tools monitor traffic, detect anomalies, and ensure security through firewalls, encryption, and access controls. Additionally, virtualization and containerization technologies enable applications to run in isolated environments, optimizing resource utilization and scalability. Through these interconnected components and processes, computer networks effectively support applications by providing the necessary infrastructure for data exchange, real-time communication, and collaborative workflows across multiple devices and locations.

Executing controls and monitoring numerous processes, workflows, and functions across different devices in a computer network is challenging due to the complexity, scale, and dynamic nature of modern networks. With multiple devices, including servers, routers, IoT devices, and user endpoints, operating across different locations, ensuring consistent performance and security becomes difficult. Each device may have different configurations, operating systems, and security requirements, making standardization a challenge. Additionally, networks are constantly evolving, with data flowing in real time, requiring continuous monitoring to detect and prevent failures, cyber threats, and inefficiencies. The decentralized nature of cloud and distributed computing further complicates visibility and control, as data and processes may span multiple environments, including on-premises, hybrid, and multi-cloud infrastructures. Cybersecurity threats such as malware, unauthorized access, and insider threats add another layer of complexity, requiring proactive security measures and compliance with industry regulations. Furthermore, network congestion, latency issues, and hardware failures can disrupt workflows, making real-time monitoring and automated response mechanisms essential.

### SUMMARY

Systems and methods are described herein for novel uses and/or improvements to executing controls and monitoring numerous processes, workflows, and functions. As one example, systems and methods are described herein for a control hub orchestration layer and a control hub component layer. The control hub orchestration layer provides improved control execution, while the control hub component layer provides for improved monitoring of processes, workflows, and functions subject to a control.

For example, with respect to control execution, a conventional orchestration layer fails to implement controls effectively due to the diverse and heterogeneous nature of data, processes, and infrastructure within a network. Traditional orchestration systems are designed to handle standardized workflows, assuming uniformity in data structures, processing logic, and execution environments. However, in real-world scenarios, data can originate from multiple unique sources, each with different formats, structures, and processing requirements. This heterogeneity creates challenges in applying uniform controls, as different data types may require distinct handling mechanisms, security policies, and computational resources. Additionally, the execution of workflows may vary depending on the underlying infrastructure, where certain types of data are processed differently based on device capabilities, storage configurations, and network conditions. The lack of dynamic adaptability in conventional orchestration layers leads to inefficiencies, inconsistencies, and potential security vulnerabilities, as they may struggle to enforce access controls, compliance policies, and real-time monitoring across disparate environments. Moreover, rigid orchestration frameworks often lack the intelligence to autonomously adjust to changes in data flow, workload distribution, or security threats, making it difficult to maintain governance and reliability at scale.

To overcome these limitations, the control hub orchestration layer provides advanced automation, real-time analytics, and flexible policy enforcement to ensure seamless and secure execution of processes across diverse and evolving network ecosystems. To achieve this, the control hub orchestration layer determines an execution pattern for a given control in the system by iteratively branching from each entry point in the system through the various nodes and dependencies of the system to generate an ontological model comprising a hierarchical structure to define relationships between different components of the system. The system may then execute controls based on the execution pattern, in which the dependencies in the hierarchical structure and thus the dependent controls needed for execution, are defined by the execution pattern.

However, iteratively branching through the system in this manner raises a novel technical problem, as the number of different components (e.g., devices, configurations, applications, and/or functions) of the system leads to undue complexity in naming conventions. As such, the system defines and/or standardizes this process by describing each component based on the data input characteristics, as opposed to the component characteristics themselves. For example, because data serves as the primary driver of workflows, defining components in terms of how they process, transform, and interact with different data inputs establishes a common structure that applies universally across various components. This approach eliminates the need to model every component's individual properties and behaviors separately, allowing for a more streamlined and hierarchical classification based on data dependencies and relationships. By focusing on data input characteristics, the system can define rules, constraints, and relationships in a modular and reusable manner, making it easier to construct an ontological model that remains scalable and adaptable to new components without requiring extensive modifications. Furthermore, as data flows through the system, its characteristics inherently define interactions between different components, naturally forming a hierarchical structure that captures dependencies, process sequences, and decision pathways. This approach reduces redundancy, simplifies integration across heterogeneous environments, and enhances interoperability, making it significantly easier to develop and maintain a comprehensive ontological model that accurately represents system relationships.

In some aspects, systems and methods for implementing control hub orchestration layers by for executing controls across diverse network ecosystems are described herein. For example, the system may receive a first request to determine a first execution pattern across a computer network for a first control. The system may, in response to the first request, determine, at a control hub orchestration layer, a first execution pattern by: determining a first entry point to the computer network for the first control based on a first input characteristic for the first control; determining a first network component corresponding to the first input characteristic; determining a second input characteristic for the first control; selecting a second network component from a plurality of network components based on the second network component corresponding to the second input characteristic; and selecting determining a hierarchical execution pathway between the first network component and the second network component.

With respect to control monitoring, a conventional orchestration layer fails to monitor controls effectively because it lacks the dynamic adaptability required to track how controls propagate through complex, evolving systems. In modern networks, as controls are implemented, their effects can change based on shifting data properties, dependencies, and execution contexts. Because different data sources and processes interact in unpredictable ways, a control that initially enforces a security policy, workflow execution, or compliance requirement may have unintended consequences downstream as data transformations and dependent processes evolve. Traditional orchestration layers, which rely on static rule-based monitoring, struggle to account for these changes, making it difficult to detect when a control is no longer functioning as intended or when its impact has been altered by new conditions. Additionally, conventional monitoring tools often lack real-time feedback mechanisms that can analyze the cascading effects of a control across distributed environments, leading to blind spots in security, compliance, and operational oversight. Without continuous, context-aware monitoring, orchestration systems may fail to detect policy violations, security breaches, or performance degradations caused by unexpected interactions between controls and changing data states.

To overcome these limitations, the control hub component layer provides anomaly detection, adaptive policy enforcement, and real-time analytics to ensure that controls remain effective and responsive as they propagate through dynamic, interdependent systems. To achieve this, the control hub component layer refers to the execution pattern of a given control. The system may then compare the outputs of a given component to the next input determined by the execution pattern. The system may further define and standardize its processes based on data output characteristics in a metric specific to the next input in the hierarchical structure of the execution pattern.

For example, rather than monitoring the control execution based on the intrinsic characteristics of each component, the system lowers the complexity of creating an ontological model by providing a more structured and outcome-oriented framework for defining relationships. This approach abstracts away the complexities of individual component behaviors and instead focuses on the measurable, quantifiable results that each component produces. Furthermore, by categorizing components based on their input metrics for the next input in the hierarchical structure of the execution pattern, the system can establish a uniform hierarchy where relationships between components are determined by how their outputs interact with or serve as inputs for other processes. This hierarchical structure becomes more intuitive and scalable, since it aligns components based on functional dependencies rather than arbitrary or highly specific technical attributes. Additionally, by defining standard output metrics according to the next input, the system reduces variability and inconsistencies across different components, allowing for seamless integration and interoperability. This methodology also simplifies adaptability, as new components can be integrated into the system as long as they conform to predefined output metrics for the next input in the hierarchy, rather than requiring extensive modifications to accommodate variations in component characteristics. Overall, by shifting the focus from component-specific traits to standardized output-driven relationships, the system enhances efficiency, reduces modeling complexity, and enables a more cohesive and maintainable ontological framework.

In some aspects, systems and methods for implementing control hub component layers by monitoring controls across diverse network ecosystems are described. For example, the system may retrieve a first execution pattern corresponding to a first control, wherein the first execution pattern comprises a hierarchical execution pathway that is predetermined for the first control by a control hub orchestration layer. The system may determine, at a control hub component layer, a first network component and a second network component corresponding to the first control based on the hierarchical execution pathway for the first execution pattern. The system may retrieve a first input characteristic and a first input metric for the second network component. The system may detect a first output characteristic for the first network component. The system may compare, using the first input metric, the first input characteristic to the first output characteristic. The system may determine, a first status for the first control, based on comparing the first input characteristic to the first output characteristic. The system may generate for display, on a user interface, the first status.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

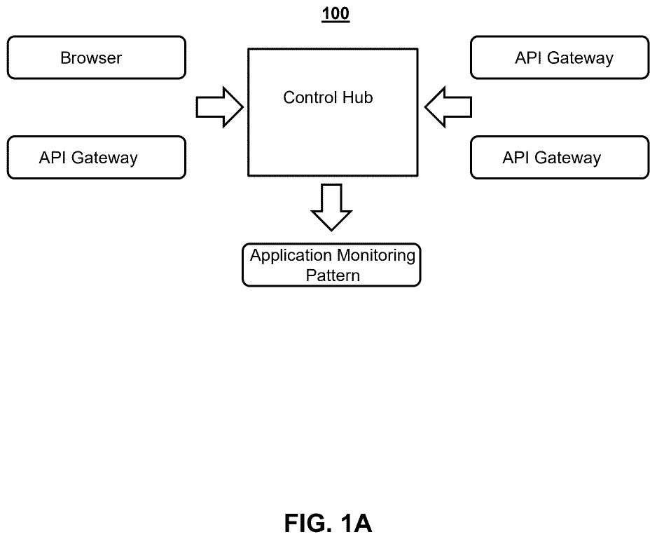

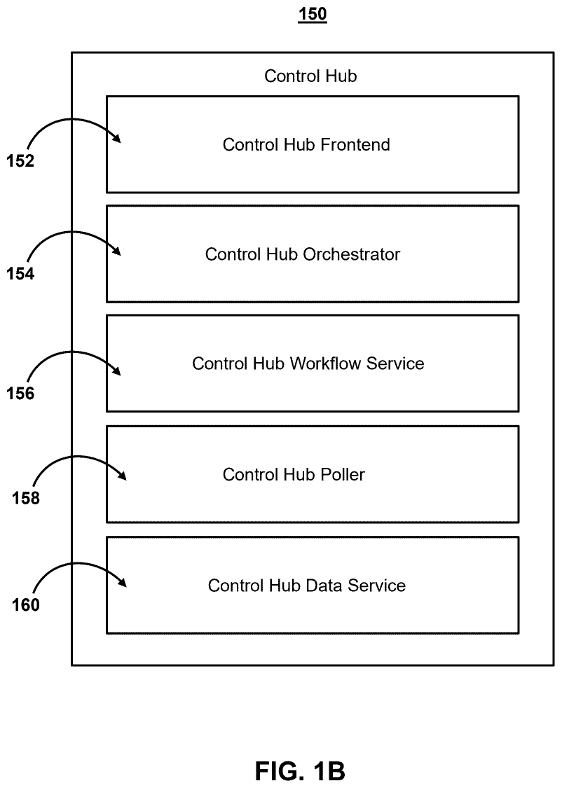

FIGS. 1A-1B show an illustrative diagram for a control hub, in accordance with one or more embodiments.

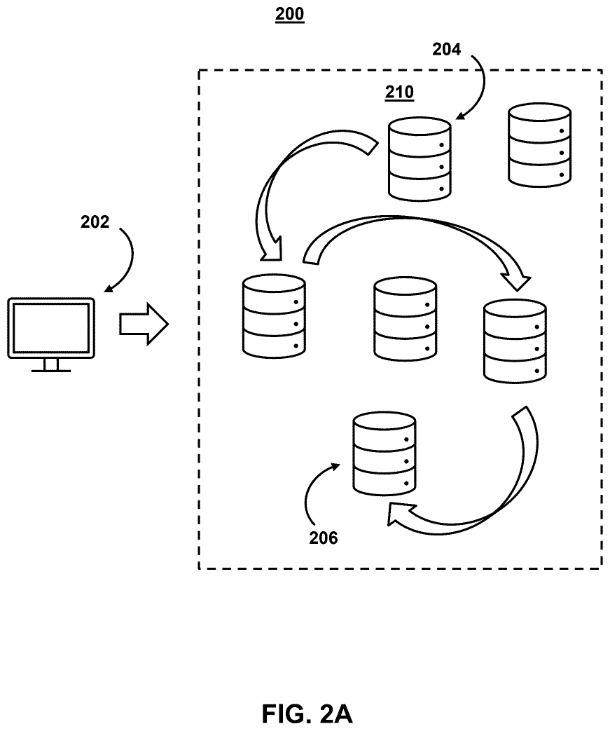

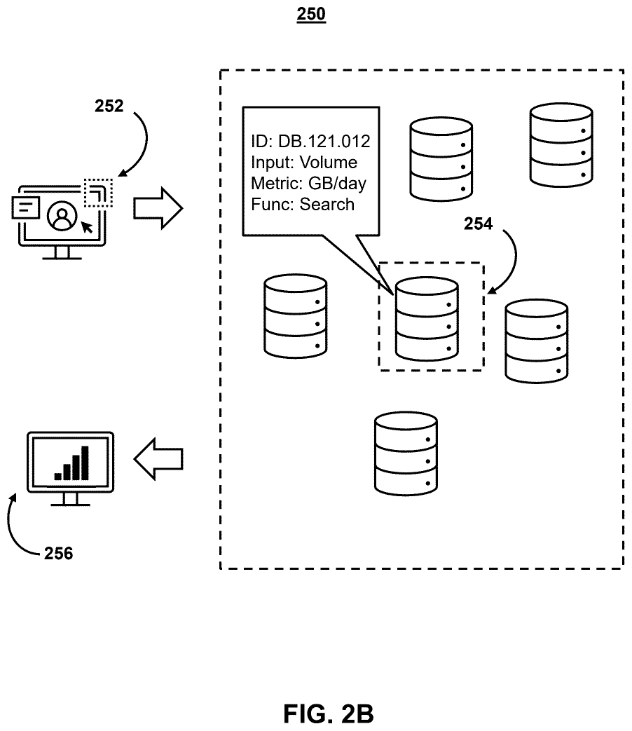

FIG. 2A-2B show an illustrative diagram for executing and monitoring controls using a control hub, in accordance with one or more embodiments.

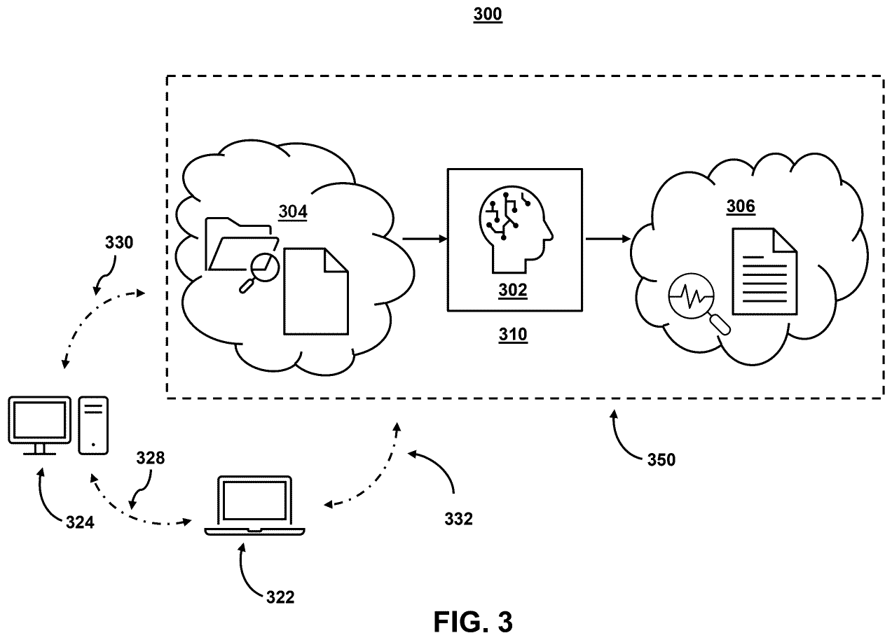

FIG. 3 shows illustrative components for a system used to facilitate the control hub, in accordance with one or more embodiments.

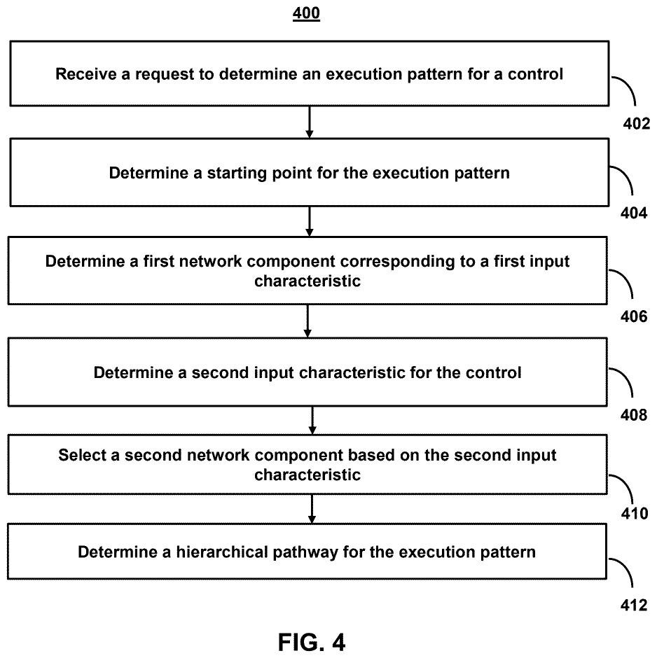

FIG. 4 shows a flowchart of the steps involved in implementing control hub orchestration layers by for executing controls, in accordance with one or more embodiments.

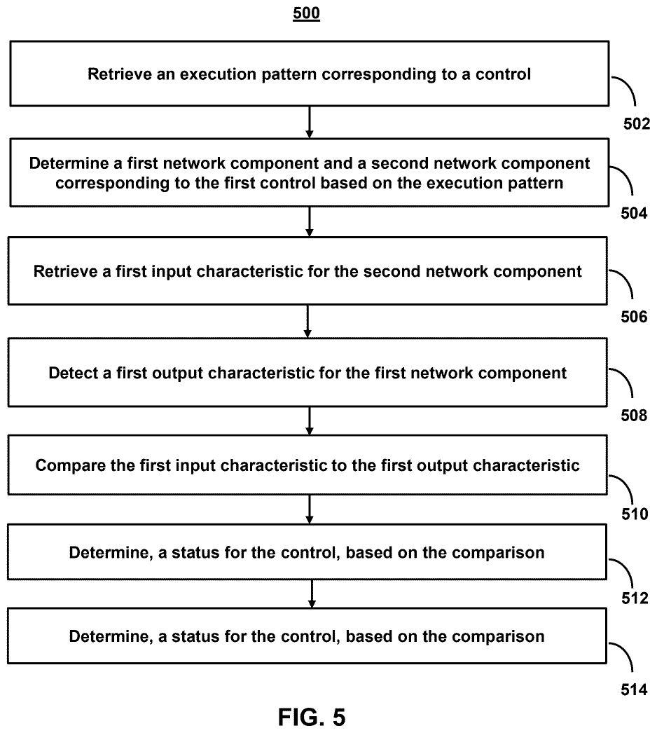

FIG. 5 shows a flowchart of the steps involved in implementing control hub component layers by for monitoring controls, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

FIGS. 1A-1B shows an illustrative diagram for a control hub, in accordance with one or more embodiments. For example, as described herein, a control hub may comprise various layers that layer provides advanced automation, real-time analytics, and flexible policy enforcement to ensure seamless and secure execution of processes across diverse and evolving network ecosystems. For example, the control hub may be a centralized system designed to enhance the reliability, consistency, observability, transparency, risk mitigation, and efficiency of control execution across organizations. It ensures that federated and centralized controls are executed uniformly, reducing variability and proactively driving action through notifications, alerts, and automated workflows. By ensuring that control execution meets predefined requirements with completeness and accuracy, a control hub improves operational reliability and strengthens compliance adherence.

A system may visualize the end-to-end process of currently running business logic by generating execution patterns for different controls that trace how data and actions flow through various components in a complex environment. Unlike conventional orchestration layers, which often struggle with enforcing controls due to the heterogeneity of data types, systems, and infrastructure, a control hub orchestration layer addresses this challenge by dynamically determining an execution pattern for each control. It does this by iteratively branching from each entry point in the system-such as data ingestion nodes, user inputs, or service triggers-through all relevant nodes and dependencies. This traversal results in the construction of an ontological model, which forms a hierarchical structure that defines the relationships between components, capturing both technical dependencies and logical process flows.

Once this model is established, the system uses the execution pattern to determine which controls to activate, and in what sequence, based on the hierarchical structure of dependencies. This ensures that each control is executed in context, with awareness of upstream and downstream dependencies. However, this branching process introduces a technical complexity: the vast diversity of components (e.g., devices, configurations, applications, functions) makes it difficult to maintain consistent naming conventions, which can hamper visibility and control execution. To overcome this, the system introduces a standardized descriptive approach by defining each component in terms of its data input characteristics, rather than its functional name or type. Since data is the driving force of workflow execution, this strategy allows the system to apply a unified structure across all components-regardless of their underlying technology-by focusing on how they process, transform, or interact with data inputs. This abstraction simplifies visualization, reduces semantic inconsistencies, and enables more scalable, data-driven orchestration and control of complex business logic.

The control hub also enhances consistency by enabling custom execution of technology controls using open-source technology and Business Process Management Notation (BPMN). It supports data sourcing, ingestion, manual tasks, and human decision-making, while digitizing as much of the human experience as possible to increase automation and reduce errors. This structured approach minimizes operational discrepancies and ensures that controls function as intended across multiple environments.

AI and machine learning (AI/ML) can be used to analyze and enhance process design by identifying inefficiencies, patterns, and optimization opportunities within complex workflows. By ingesting historical and real-time process data, AI/ML algorithms can detect bottlenecks, predict delays, and uncover hidden dependencies that may not be evident through manual analysis. These insights allow organizations to redesign processes for improved efficiency, scalability, and resilience. Machine learning models can also simulate the impact of proposed changes, enabling data-driven decisions before implementation. Additionally, AI can enhance process design by automatically recommending optimized workflows, control logic, or resource allocations based on contextual factors such as workload variability, user behavior, or system performance. In more advanced applications, AI can continuously learn from ongoing operations to adapt and refine process design dynamically, ensuring that processes evolve alongside business needs and environmental changes.

With advanced observability and notification features, the control hub allows users to set custom reminders, trigger approval routing prompts, and implement time-based escalations for control execution. Its ability to integrate with various communication services ensures that stakeholders remain informed, improving responsiveness and compliance tracking. Transparency is another key function, as a control hub tracks every aspect of control execution, including data collection, approval steps, attestations, health monitoring, and evidence storage, making audits and reporting seamless.

In some embodiments, the control hub enables users to manage control execution with precision by allowing them to set custom reminders, trigger approval routing prompts, and implement time-based escalations tailored to specific workflows. Users can configure these settings to align with business policies, compliance requirements, or operational preferences. For instance, a user may schedule a reminder to review a pending control after a defined interval or trigger an approval prompt when a control reaches a critical decision point. The control hub supports on-demand provisioning and deprovisioning of resources-such as control instances, approval chains, or related processes-by dynamically initiating or terminating them based on real-time events, user actions, or predefined schedules. This ensures that controls are only active when needed, reducing overhead and improving system efficiency. Additionally, the control hub features a built-in escalation mechanism that monitors time-sensitive steps and automatically escalates notifications if actions are not taken within specified timeframes. This may involve alerting higher-level stakeholders, re-routing the approval flow, or invoking alternate execution paths to prevent delays or compliance breaches. Through this comprehensive, automated approach, the control hub ensures timely execution of controls while providing users with the flexibility and accountability needed to manage complex operational workflows.

From a risk mitigation standpoint, the control hub streamlines control performer execution, offering key data insights that help organizations proactively identify and reduce risks in business operations. Furthermore, it boosts efficiency by optimizing workflow automation, reducing the time required for teams to execute controls, and minimizing human intervention in repetitive tasks.

FIG. 1A shows control hub 100. As shown in FIG. 1A, control hub 100 may be a centralized system, platform, or interface that manages, monitors, and coordinates various operations, workflows, and data flows within a network, infrastructure, or organization. It serves as the command center for overseeing compliance enforcement, security protocols, system performance, and data governance across interconnected components. Control hub 100 may integrate automation, analytics, and real-time monitoring to ensure seamless operations, regulatory adherence, and risk mitigation. In industries such as finance, cybersecurity, and cloud computing, control hub 100 can manage network traffic, security policies, regulatory compliance checks, and AI-driven decision-making processes. For example, in a financial institution, control hub 100 may monitor real-time transactions for fraud detection, enforce firewall configurations, and ensure compliance with financial regulations like PCI-DSS and AML requirements. In cybersecurity, control hub 100 may act as a Security Operations Center (SOC) dashboard, aggregating threat intelligence, intrusion detection alerts, and incident response actions in a unified interface.

A control hub (e.g., control hub 100) can be integrated with multiple components, devices, and applications to provide seamless automation, observability, compliance enforcement, and centralized control execution. This integration enables organizations to streamline workflows, enforce security policies, enhance data visibility, and improve operational efficiency across diverse systems.

Control hub 100 may be integrated with a user interface in order to allow users access to control hub 100. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring.

Control hub 100 can be integrated with a browser, allowing users to access real-time dashboards, compliance monitoring interfaces, and workflow automation tools directly from a web-based environment. Through browser extensions or web-based control panels, users can interact with the hub to monitor alerts, approve control execution steps, review compliance reports, and initiate remediation actions without needing separate applications.

Additionally, control hub 100 can be integrated with an application monitoring pattern, allowing it to track, analyze, and optimize application performance and compliance. This integration enables the hub to collect telemetry data, system logs, error reports, and security events from various applications, ensuring that they meet predefined control requirements. By continuously analyzing system performance, security incidents, and configuration changes, the control hub can trigger alerts, recommend optimizations, or enforce corrective actions when anomalies or compliance violations are detected.

Control hub 100 may also be integrated with a plurality of API gateways, which allows it to communicate with different enterprise applications, cloud services, and third-party platforms. API gateway integration enables secure, scalable, and real-time data exchange between the control hub and connected systems. For example, control hub 100 can integrate with financial transaction monitoring APIs, security policy enforcement systems, identity and access management (IAM) platforms, and regulatory compliance databases. This allows it to automate security controls, validate data integrity, enforce authentication protocols, and synchronize compliance records across multiple ecosystems.

By leveraging API gateways, browser-based interfaces, and application monitoring, control hub 100 ensures a highly interconnected, adaptive, and intelligent control framework. It can automate governance, detect risks, and enforce compliance in real-time, making it a powerful tool for organizations managing complex digital infrastructures, regulatory mandates, and security controls.

FIG. 1B shows the various layers of control hub 150 (which may correspond to control hub 100 (FIG. 1A)). Control hub 150 includes frontend layer 152, orchestrator layer 154, workflow service layer 156, poller layer 158, data service layer 160, and/or one or more other component layers.

A control hub (e.g., control hub 150) consists of multiple layers that work together to provide seamless control execution, compliance enforcement, automation, and data integration across various enterprise systems. Each layer in the control hub stack plays a distinct role in managing the flow of information, processing business logic, and ensuring secure communication between applications, services, and users.

The frontend layer (e.g., frontend layer 153) serves as the user interface (UI) component, enabling users to interact with the control hub through web applications, dashboards, or mobile interfaces. This layer is responsible for visualizing compliance metrics, displaying alerts, processing approvals, and allowing manual control execution steps. The frontend layer ensures that users can efficiently monitor and manage control processes while providing an intuitive experience for both administrators and auditors.

The orchestrator layer (e.g., orchestrator layer 154) is the central control engine that coordinates various system components, ensuring that workflows are executed in the correct sequence and dependencies are managed efficiently. It acts as the middleware that links API requests, backend services, and third-party integrations, ensuring that control processes are executed, monitored, and enforced consistently across the organization.

The workflow service layer (e.g., workflow service layer 156) manages process automation and business logic execution, enabling organizations to define, modify, and optimize control workflows. This layer digitizes business processes, supports Business Process Model and Notation (BPMN) for workflow automation, and ensures that controls are executed with predefined logic, approval steps, and conditional triggers. It allows organizations to automate manual compliance tasks, reducing operational risk and human error.

The poller layer (e.g., poller layer 158) is responsible for real-time data synchronization and event-driven processing. It continuously listens for updates, changes, or new control execution tasks from connected systems and applications, ensuring that the control hub always has the most up-to-date information. This layer is essential for ensuring compliance monitoring and risk detection in dynamic environments, such as financial transactions, cloud security policies, or IT infrastructure changes.

The data service layer (e.g., data service layer 160) functions as the data storage and retrieval layer, managing compliance records, audit logs, historical execution data, and real-time control insights. It ensures that data is stored securely, indexed efficiently, and retrieved quickly for compliance audits, reporting, and forensic analysis. This layer may integrate with databases, data lakes, regulatory repositories, and secure evidence storage systems to ensure full transparency and traceability of control execution.

In some embodiments, evidence capture and storage is performed by the system through a dedicated data service layer, such as data service layer 160, which serves as the central repository for managing all data related to control execution. This layer is responsible for capturing a wide range of evidence artifacts—including compliance records, audit logs, historical execution data, and real-time control insights—as controls are executed across the system. The data service layer ensures that this information is securely stored, using encryption and access controls to meet regulatory and organizational security standards. It also indexes the data efficiently to enable fast retrieval, supporting the needs of compliance audits, reporting, and forensic analysis. To achieve full transparency and traceability, the data service layer integrates with various backend systems, such as databases, data lakes, regulatory repositories, and secure evidence storage platforms, allowing it to store both structured and unstructured data. This integration supports automated evidence capture at every stage of control execution, ensuring a tamper-evident and audit-ready trail that reflects exactly how, when, and by whom controls were executed, approved, escalated, or bypassed. By maintaining this comprehensive and accessible evidence layer, the system strengthens accountability and ensures ongoing compliance with internal policies and external regulations.

In addition to these core layers, a control hub may include other component layers, such as security enforcement layers, which manage identity and access control (IAM), authentication protocols (e.g., OAuth, SAML), and encryption policies, ensuring that only authorized users and systems can interact with the hub. An API gateway layer enables seamless integration with external applications and third-party compliance systems, while an analytics and AI layer can provide predictive insights, anomaly detection, and risk scoring based on historical control execution patterns. By combining these multiple layers, control hub 150 ensures a robust, scalable, and automated framework for managing compliance, security enforcement, operational controls, and workflow execution in enterprise environments.

FIG. 2A-2B shows an illustrative diagram for executing and monitoring controls using a control hub, in accordance with one or more embodiments. FIG. 2A shows system 200 used to determine an execution pattern for a control. For example, system 200 may receive a request via user interface 202 and determine an execution pattern for a control across network 210.

Network 210 may comprise a computer network, blockchain network, and/or other networks. For example, network 210 may comprise multiple components, including devices, routers, applications, and other infrastructure elements, that work together to enable data transmission, communication, security enforcement, and operational functionality. These components ensure that information flows efficiently, securely, and reliably across connected systems, whether in enterprise networks, cloud environments, financial institutions, or industrial control systems.

Devices in network 210 may include end-user devices such as computers, mobile phones, tablets, and IoT sensors, which serve as the primary access points for users and automated systems. These devices generate, consume, and transmit data across the network, interacting with applications, databases, and cloud services. Servers are another critical device type, responsible for processing requests, storing data, and hosting applications in on-premises, cloud, or hybrid environments. Routers and switches play a key role in network infrastructure by managing data traffic, directing packets, and optimizing connectivity between different network segments. Routers are responsible for forwarding data between networks, often connecting local area networks (LANs) to wide area networks (WANs) or the internet. Switches, on the other hand, operate within a LAN, ensuring that devices communicate efficiently by forwarding data to the correct destination based on MAC addresses. Firewalls function as security devices, filtering incoming and outgoing traffic based on predefined rules to protect against unauthorized access, malware, and cyber threats.

Applications in network 210 may include enterprise software, cloud services, monitoring tools, and security platforms that support various business functions. These applications may include customer relationship management (CRM) systems, enterprise resource planning (ERP) software, financial transaction systems, and compliance monitoring tools. Additionally, network monitoring applications help administrators analyze traffic patterns, detect anomalies, and optimize performance through real-time visibility into network activity.

Other key network components include API gateways, VPN servers, load balancers, and content delivery networks (CDNs), which enhance security, scalability, and performance. API gateways enable secure communication between internal and external services, while VPN servers encrypt data transmissions for remote access. Load balancers distribute network traffic across multiple servers to prevent congestion and ensure availability, and CDNs optimize content delivery by caching data at distributed locations to reduce latency and improve performance. Overall, these network components work together to enable communication, enforce security policies, manage compliance, optimize performance, and ensure seamless data exchange within an organization or across distributed environments.

Each component in network 210 may comprise one or more input characteristics. As described herein, an input characteristic may comprise any characteristic that distinguishes one component from another. For example, input characteristics for the components of a network (e.g., network 210) may refer to the data, signals, parameters, and configurations that each network component receives to function efficiently and securely. These input characteristics vary based on the type of component, its role in the network, and the specific operations it performs, ensuring that data transmission, security enforcement, traffic management, and application processing occur as intended.

For end-user devices such as computers, mobile phones, and IoT sensors, input characteristics include user credentials, software configurations, data packets, authentication tokens, and network policies. For example, when a user accesses a corporate network, the device receives an IP address, DNS configurations, and security permissions from the network infrastructure.

For routers and switches, input characteristics include network traffic, routing tables, MAC addresses, and packet forwarding rules. A router receives incoming data packets, applies NAT (Network Address Translation), and determines the best path for packet forwarding based on routing protocols like BGP (Border Gateway Protocol) or OSPF (Open Shortest Path First). Switches process Ethernet frames, VLAN tags, and Quality of Service (QoS) settings to ensure optimal communication within a LAN.

For firewalls and security appliances, input characteristics consist of network access control lists (ACLs), threat intelligence feeds, intrusion detection alerts, decryption policies, and firewall rules. A firewall receives data packets from external and internal sources, inspects them against predefined security rules, and either allows, blocks, or flags traffic for further inspection.

For enterprise applications and cloud services, input characteristics include API requests, database queries, authentication tokens, encryption keys, and access control policies. A cloud-based financial transaction system, for example, receives encrypted payment data, identity verification parameters, and fraud detection signals to ensure secure and compliant transaction processing.

For network monitoring tools and compliance platforms, input characteristics include traffic logs, system health metrics, performance indicators, and anomaly detection triggers. A network monitoring system, such as SIEM (Security Information and Event Management), ingests real-time log data from firewalls, intrusion detection systems (IDS), and endpoint security solutions to detect cyber threats and operational anomalies.

System 200 may determine an entry point in network 210 based on input characteristics for a component in network 210. For example, system 200 may determine that component 204 corresponds to an entry point based on the input characteristics for component 204. For example, the system (e.g., system 200) determines an entry point in a network (e.g., network 210) by analyzing the input characteristics of various network components to identify where data, users, or external systems first interact with the network infrastructure. An entry point is a critical gateway or access location where network traffic originates, whether from internal devices, external sources, remote connections, or third-party integrations. These entry points play a crucial role in security enforcement, access control, and network monitoring, as they are often the first location where authentication, traffic filtering, and compliance enforcement take place.

To determine an entry point, system 200 first collects and analyzes input characteristics from different components in network 210. This includes IP address assignments, API request patterns, user authentication logs, firewall rule enforcement, and network flow telemetry. For example, if component 204 is a VPN server, system 200 may detect that it receives encrypted remote access requests, validates multi-factor authentication (MFA) credentials, and forwards traffic into the internal network, indicating that component 204 is a primary entry point for remote users. Similarly, if component 204 is a load balancer, system 200 may identify that it is receiving high volumes of inbound traffic from external web clients, distributing requests to backend servers, and enforcing SSL/TLS encryption policies. This suggests that component 204 functions as an entry point for external users accessing cloud applications or enterprise services.

In another scenario, if component 204 is a firewall or network gateway, system 200 may detect that it processes inbound traffic from untrusted networks, applies intrusion detection rules, and logs packet filtering decisions. This input characteristic confirms that component 204 is a critical network entry point, enforcing security policies and preventing unauthorized access. Once system 200 determines that component 204 corresponds to an entry point, it may perform further analysis to understand its role in network security and data flow management. This could include evaluating access policies, assessing potential vulnerabilities, monitoring suspicious activities, or optimizing routing strategies. By identifying, analyzing, and securing entry points, system 200 helps enhance network security, enforce compliance, and optimize operational efficiency, ensuring that only authorized traffic flows into the network while mitigating risks from unauthorized or malicious access attempts.

System 200 may determine an exit point in network 210 based on input characteristics for a component in network 210. For example, system 200 may determine that component 206 corresponds to an exit point based on the input characteristics for component 206. For example, a system (e.g., system 200) determines an exit point in a network (e.g., network 210) by analyzing the input characteristics of various network components to identify where data, traffic, or communications leave the network toward an external destination. An exit point is a critical location where outbound traffic flows from internal systems to external networks, cloud services, third-party platforms, or remote users. These exit points play a crucial role in security enforcement, compliance monitoring, and data integrity, as they are often where firewall policies, data loss prevention (DLP) rules, and traffic logging mechanisms are applied to prevent unauthorized data exfiltration and policy violations.

To determine an exit point, system 200 first analyzes input characteristics from different components in network 210, focusing on traffic patterns, destination addresses, protocol types, and policy enforcement mechanisms. If component 206 is identified as handling outbound traffic destined for external servers, cloud services, or remote endpoints, system 200 classifies it as an exit point.

For example, if component 206 is a secure web gateway (SWG), system 200 may detect that it is receiving outbound web requests, filtering content, applying URL categorization policies, and enforcing access restrictions. This suggests that component 206 serves as an exit point for internet-bound traffic from enterprise users. Similarly, if component 206 is a network firewall, system 200 may identify that it is inspecting, logging, and filtering outbound traffic to prevent unauthorized data transfers, unapproved protocol use, or suspicious external communications. This confirms that component 206 acts as a controlled exit point, enforcing compliance policies, such as blocking unauthorized file uploads or restricting access to external storage services. If component 206 is a proxy server, system 200 may analyze its input characteristics and determine that it receives outbound HTTP/S traffic, anonymizes requests, and routes them to external web servers, making it an exit point for internet communications while enforcing security and privacy controls. Once system 200 determines that component 206 corresponds to an exit point, it may perform further analysis to evaluate traffic compliance, anomaly detection, encryption enforcement, and risk assessment. This could include ensuring that outbound data adheres to regulatory policies (e.g., GDPR, PCI-DSS), detecting data exfiltration attempts, or optimizing outbound bandwidth allocation.

System 200 may then complete the execution pattern for the control across network 210 by determining a sequence between component 204 and component 206. For example, the system may determine an execution pattern for a given control by iteratively branching from each entry point in network 210 through the various nodes and dependencies of the system to generate an ontological model comprising a hierarchical structure to define relationships between different components of the system. System 200 may then execute controls based on the execution pattern, in which the dependencies in the hierarchical structure and thus the dependent controls needed for execution, are defined by the execution pattern.

For example, the system (e.g., system 200) completes the execution pattern for a control across network 210 by determining a sequence between component 204 (entry point) and component 206 (exit point). This process involves mapping network flows, identifying dependencies, and establishing a structured execution model that ensures controls are applied systematically and in compliance with security and regulatory policies. By iteratively branching from each entry point in network 210 through various nodes, dependencies, and operational workflows, the system constructs an ontological model that captures the hierarchical relationships between network components.

To generate an execution pattern, system 200 begins by identifying all possible paths between entry and exit points based on traffic flow, security rules, and operational constraints. Using graph-based modeling and dependency resolution techniques, the system iterates through each node and its associated controls, mapping out how data, processes, or security policies propagate through network 210. This hierarchical ontological model defines relationships between network components, such as which firewall policies apply to which data streams, which encryption protocols are required at certain nodes, and how authentication is enforced before traffic reaches a secure exit point.

Once the execution pattern is established, system 200 determines dependent controls based on the hierarchical structure of the model. Each node in the sequence inherits control requirements from upstream dependencies, ensuring that execution follows a logical, rule-based framework. For example, if component 204 (an API gateway) enforces identity verification, system 200 ensures that subsequent nodes require access logs and security tokens before allowing outbound transmission through component 206 (a network firewall or proxy server). This approach guarantees that all compliance, security, and operational rules are enforced in the correct sequence before traffic leaves the network.

With the execution pattern defined, system 200 executes the required controls across network 210, dynamically adjusting for real-time security threats, policy updates, or system changes. By continuously monitoring network flow dependencies, the system can detect deviations from expected control sequences, triggering automated remediation actions or alerts when anomalies occur. Ultimately, this structured execution framework allows system 200 to enforce governance policies, optimize security configurations, and ensure compliance in a scalable and automated manner, making network 210 more resilient, transparent, and adaptive to evolving operational needs.

However, iteratively branching through the system in this manner raises a novel technical problem as the number of different components (e.g., devices, configurations, applications, and/or functions) of the system leads to undue complexity in naming conventions. As such, the system defines and/or standardizes this process by describing each component based on the data input characteristics as opposed to the component characteristics themselves. For example, because data serves as the primary driver of workflows, defining components in terms of how they process, transform, and interact with different data inputs establishes a common structure that applies universally across various components.

For example, the system standardizes and defines the process of generating an execution pattern by describing each component based on its data input characteristics rather than the component's intrinsic properties. This approach ensures a data-centric execution model, where the flow, transformation, and interaction of data dictate how components operate within a network, rather than being constrained by the structural differences of the components themselves. Since data serves as the primary driver of workflows, defining components by their data-processing behavior establishes a universal framework that applies consistently across varied network architectures, applications, and security controls.

To implement this standardized execution pattern, the system first identifies the data input characteristics of each component, such as data formats, validation rules, encryption levels, processing logic, transmission protocols, and security policies. Instead of treating a router, firewall, API gateway, or database as isolated components with unique functionalities, the system classifies them based on how they ingest, modify, and relay data. For example, instead of describing a firewall solely by its hardware or software properties, the system defines it based on how it filters, inspects, and forwards network packets, ensuring that its role within the workflow is understood in relation to data flow and control enforcement.

Once all components are defined in terms of their data-handling characteristics, the system generates an execution pattern by modeling how data propagates across network pathways, security controls, and operational workflows. This involves mapping dependencies between components based on data flow sequencing rather than static component relationships. For example, if component 204 (an API gateway) processes inbound authentication data before passing it to component 206 (a transaction validation system), the execution pattern is defined by the data verification, transformation, and handoff process, rather than simply connecting two components based on predefined relationships.

By standardizing execution in this way, the system ensures that workflow automation, compliance enforcement, and security controls remain scalable, adaptable, and applicable across heterogeneous environments. This method also enables interoperability between different architectures, ensuring that policy enforcement, risk detection, and regulatory compliance can be consistently applied across cloud, on-premises, and hybrid infrastructures. Additionally, because the execution pattern is defined by data input and transformation rules, any new components introduced to the system can be seamlessly integrated by aligning with the existing data-driven control framework. Ultimately, this data-centric approach enhances network governance, workflow automation, and security compliance by ensuring that all components operate within a standardized execution model, regardless of underlying infrastructure or vendor-specific implementations.

This approach eliminates the need to model every component's individual properties and behaviors separately, allowing for a more streamlined and hierarchical classification based on data dependencies and relationships. By focusing on data input characteristics, the system can define rules, constraints, and relationships in a modular and reusable manner, making it easier to construct an ontological model that remains scalable and adaptable to new components without requiring extensive modifications. Furthermore, as data flows through the system, its characteristics inherently define interactions between different components, naturally forming a hierarchical structure that captures dependencies, process sequences, and decision pathways. This approach reduces redundancy, simplifies integration across heterogeneous environments, and enhances interoperability, making it significantly easier to develop and maintain a comprehensive ontological model that accurately represents system relationships.

FIG. 2B shows system 250 used to monitor execution of a control based on a determined execution pattern. For example, system 250 may receive a request (e.g., via user interface 252) to monitor the execution of a control. The system may detect, based on an execution pattern for the control, a component used to execute the control. System 250 may retrieve a first input characteristic and a first input metric for a network component (e.g., component 254) based on an execution pattern. System 250 may then determine a status (e.g., status 256) of the control based on comparing, using the first input metric, the first input characteristic to the first output characteristic.

For example, the system (e.g., system 250) monitors the execution of a control by leveraging a determined execution pattern, ensuring that each step in the control process follows predefined functional dependencies and data flow relationships. The process begins when system 250 receives a request (e.g., via user interface 252) to monitor a specific control's execution within a networked environment. This request may be initiated by an administrator, an automated compliance system, or a security monitoring process to track whether a control is being properly executed and enforced.

Upon receiving the request, system 250 detects a relevant network component (e.g., component 254) that is used in executing the control based on an established execution pattern. This execution pattern defines how data flows through different components and identifies the dependencies between control execution steps, ensuring that each component processes inputs and generates expected outputs in a structured sequence.

Next, system 250 retrieves an input characteristic and an input metric associated with component 254 based on the execution pattern. These input characteristics describe the expected format, validation rules, security policies, or operational parameters that component 254 should process as part of the control execution. The input metric provides a quantifiable measure of how the input should be evaluated, such as latency thresholds, authentication validation percentages, compliance scoring, or anomaly detection markers.

To assess whether the control is functioning correctly, system 250 determines the status (e.g., status 256) of the control by comparing the retrieved input characteristic with the current output characteristic of the network component directly preceding component 254 in the execution pattern. This ensures that the expected data transformation, validation, or security enforcement occurred before the data reached component 254. If the comparison indicates that the input characteristic aligns with the expected output from the prior component, the system determines that the control is executing as expected. However, if the current output characteristic deviates from the expected input metric—such as a missing authentication token, incorrect data formatting, unexpected delays, or failed encryption enforcement—the system may flag an execution failure, security risk, or compliance violation.

By continuously monitoring the execution pattern, system 250 ensures real-time observability, automated compliance tracking, and proactive risk detection. This monitoring framework enables organizations to enforce security policies, optimize operational workflows, and detect anomalies without requiring manual intervention at every control execution point. Additionally, if discrepancies are found, system 250 can trigger alerts, recommend remediation steps, or automatically adjust execution parameters to restore proper control function.

Ultimately, by comparing input characteristics with expected execution outputs, system 250 provides a scalable, structured, and automated approach to monitoring control execution, ensuring that critical security, compliance, and operational controls are enforced consistently across the network.

For example, A system (e.g., system 250) abstracts away the complexities of individual component behaviors by shifting its focus from component-specific characteristics to the measurable, quantifiable results that each component produces. Instead of modeling network components based on their unique technical attributes, the system monitors control execution through the intrinsic characteristics (e.g., input characteristics) of each component, ensuring a structured, outcome-oriented approach to defining relationships. By leveraging input characteristics as the foundation of the execution model, the system simplifies the creation of an ontological model by focusing on how components interact with data rather than how they individually function.

This abstraction allows system 250 to lower modeling complexity by creating a hierarchical structure where relationships between components are determined by functional dependencies rather than arbitrary technical attributes. Each component is categorized based on its input metrics, ensuring that the system builds a uniform, scalable execution pattern where components are naturally aligned according to how their outputs interact with or serve as inputs for other processes. By structuring components in this manner, the hierarchical model becomes more intuitive, enabling better visualization, monitoring, and adaptability across different environments.

Additionally, the system enforces standard output metrics for each component, ensuring that one component's output seamlessly serves as the required input for the next component in the execution hierarchy. This reduces variability and inconsistencies, making it easier to integrate diverse components while maintaining interoperability across different systems, architectures, and vendor technologies. By establishing standardized data exchange and processing rules, the system enables a uniform workflow execution pattern, eliminating the need for customized mappings when new components are introduced.

This methodology also enhances adaptability, as new components can be integrated into the system as long as they conform to predefined output metrics that match the expected input requirements of the next step in the hierarchy. Unlike traditional approaches that require extensive modifications to accommodate component-specific behaviors, this input-output alignment model ensures that the system remains highly flexible, scalable, and maintainable.

By shifting from component-specific modeling to standardized output-driven relationships, the system enhances operational efficiency, streamlines data processing, reduces modeling complexity, and ensures that the ontological framework remains cohesive and adaptable. This abstraction ultimately allows organizations to implement control execution monitoring, compliance enforcement, and workflow automation with greater consistency and efficiency, while ensuring that the network remains scalable and future-proof.

FIG. 3 shows illustrative components for a system used to facilitate the control hub, in accordance with one or more embodiments. For example, FIG. 3 may show illustrative components for implementing control hub component layers by monitoring controls and/or implementing control hub orchestration layers by executing controls. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310.

Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific, such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together, include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review, as the process by which the results are made may be unknown or obscured. This obscurity can create hurdles for identifying errors in the results, as well as improving the models providing the results.

The system can leverage AI for BPMN (Business Process Model and Notation) design by reading and interpreting the XML structure underlying BPMN diagrams to both generate new designs and optimize existing ones. By parsing the XML, the AI can understand the full definition of the process-including tasks, gateways, events, sequences, and data associations- and use this as a structured input for analysis. For building new designs, AI can learn from historical BPMN patterns and business goals to suggest or auto-generate process flows that align with best practices, reduce redundancy, and ensure compliance. For optimizing current designs, AI can evaluate the XML-defined logic to identify inefficiencies such as unnecessary steps, process bottlenecks, or misaligned task sequences. It can then recommend improvements such as reordering tasks, parallelizing steps, or simplifying conditional paths. Additionally, AI can simulate alternative flows and predict performance outcomes to help designers make data-driven decisions. This intelligent interpretation and manipulation of BPMN XML enables the system to support dynamic, responsive, and continuously improving process modeling within complex business environments.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an execution pattern, an entry point, an exit point, an input characteristic, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function, such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., an execution pattern, an entry point, an exit point, an input characteristics, etc.). In some embodiments, the model (e.g., model 302) may automatically perform actions based on outputs 306. In some embodiments, the model (e.g., model 302) may not perform any actions. The output of the model (e.g., model 302) may be used to determine an execution pattern, an entry point, an exit point, an input characteristic, etc.

In some embodiments, the system may generate predictions related to financial services. For example, the system may use one or more models and/or application to process a variety of data to generate predictions for tasks, such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task.

Additionally, or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

FIG. 4 shows a flowchart of the steps involved in implementing control hub orchestration layers by for executing controls, in accordance with one or more embodiments. For example, the system may use process 400 (e.g., as implemented on one or more system components described above) in order to implement control hub orchestration layers by for executing controls across diverse network ecosystems.

At step 402, process 400 (e.g., using one or more components described above) receives a request to determine an execution pattern for a control. For example, the system may receive a first request to determine a first execution pattern across a computer network for a first control. A system receives a first request to determine a first execution pattern across a computer network for a first control through a structured process that involves user input, automated monitoring triggers, or compliance enforcement mechanisms. The request may originate from a user interface, an external compliance system, a security monitoring tool, or an automated rule engine that detects the need to establish or validate a control's execution across the network.

In some embodiments, upon receiving the request, the system first identifies the control's purpose and scope, determining whether it relates to security enforcement, regulatory compliance, operational governance, or performance optimization. For example, if the control is intended to enforce firewall rules, access policies, or encryption standards, the system retrieves the relevant control definitions, policy requirements, and expected data flow parameters to ensure the execution pattern aligns with predefined organizational or regulatory guidelines.

At step 404, process 400 (e.g., using one or more components described above) determines a starting point for the execution pattern. For example, the system may, in response to the first request, determine, at a control hub orchestration layer, a first execution pattern by determining a first entry point to the computer network for the first control based on a first input characteristic for the first control.

For example, in response to the first request, the system determines a first execution pattern at a control hub orchestration layer by identifying the first entry point into the computer network for the first control, based on a first input characteristic that defines how the control is initiated. This process ensures that control execution is structured, data-driven, and aligned with network security, compliance, or operational governance requirements. The control hub orchestration layer serves as the central coordination point for evaluating and enforcing controls across the network. When the request is received, the system analyzes the first input characteristic of the control, which defines the type of data, transaction, or network event that triggers control execution. The input characteristic may include network traffic attributes, authentication requests, API calls, data validation checks, or system-generated security alerts, depending on the purpose of the control.

Using this first input characteristic, the system scans the network architecture to identify the first entry point—the initial component responsible for processing incoming control-related data. This could be a firewall, an API gateway, a VPN server, an authentication system, or an external data ingestion endpoint. For example, if the control is designed to enforce access policies for incoming user authentication requests, the system may determine that a Single Sign-On (SSO) authentication server or an Identity and Access Management (IAM) gateway serves as the first entry point. Similarly, if the control relates to packet inspection for compliance monitoring, the system may identify a network firewall or intrusion detection system (IDS) as the first entry point.

Once the system identifies the entry point, it validates its role in the control execution sequence by checking historical network telemetry, access logs, and real-time monitoring data to ensure that the selected entry point is actively processing relevant data streams. If discrepancies exist—such as a mismatch between the expected and actual traffic flow—the system may refine its selection by dynamically adjusting the execution pattern to reflect real-world conditions.

After the first entry point is established, the control hub orchestration layer integrates this information into the first execution pattern, mapping how data flows from this entry point through subsequent network components, security policies, and compliance enforcement mechanisms. This execution pattern serves as the foundation for monitoring, automation, and enforcement, ensuring that the control functions correctly across the entire network infrastructure. By structuring execution based on input characteristics rather than component-specific attributes, the system creates a scalable and adaptable control framework, enabling consistent enforcement, automated anomaly detection, and efficient governance in evolving network environments.

In some embodiments, the system may determine the first entry point to the computer network for the first control based on the first input characteristic for the first control further by determining a plurality of network components activated by the first control, determining a plurality of input characteristics for the plurality of network components, and comparing the plurality of input characteristics to determine an order at which the first input characteristic and the second input characteristic are generated. For example, once the system has identified the network components relevant to the first control, it determines a plurality of input characteristics associated with these components. An input characteristic defines how a component processes, validates, and reacts to incoming data within the execution framework. Examples of input characteristics include authentication tokens for access control, network packet signatures for intrusion detection, encryption parameters for secure communication, and compliance flags for regulatory enforcement. To determine the first entry point, the system compares the plurality of input characteristics to establish an execution order—determining which input characteristics are generated first and how they trigger subsequent control actions. This comparison allows the system to identify the component responsible for handling the first input characteristic, marking it as the first entry point in the execution pattern. For example, if the first control is a security policy enforcing data encryption for incoming transactions, the system may analyze the sequence in which network components process encryption-related input characteristics. If an API gateway receives an unencrypted request first, applies an encryption protocol, and then forwards the encrypted data to a firewall for inspection, the API gateway would be identified as the first entry point because it processes the initial, unprotected data before encryption is enforced.

In some embodiments, the system may determine the first entry point to the computer network for the first control based on the first input characteristic for the first control further by determining a plurality of network components activated by the first control and inputting the plurality of network components into a first model to determine an order at which the first input characteristic and the second input characteristic are generated. For example, once the system has identified the relevant network components, it inputs this plurality of components into a first model, which is designed to analyze execution sequencing and determine input-output dependencies. The model evaluates how each component processes its respective input characteristics, allowing the system to determine the order in which different input characteristics are generated. The model may be a graph-based dependency model, a machine learning-based prediction model, or a rule-based execution engine, depending on the complexity and adaptability required. For example, the system may use a graph-based execution model where each network component is treated as a node, and its input-output relationship with other components is analyzed. If an API gateway receives an unencrypted request, applies an encryption protocol, and then forwards the encrypted data to a firewall, the model will determine that the unencrypted request serves as the first input characteristic and that the API gateway is the first entry point because it is the first to process incoming data before any security transformation occurs. By inputting these components into the first model, the system calculates the correct order in which input characteristics are generated and determines that the IAM service is the first entry point because it receives and processes user credentials before security permissions are enforced at the firewall. This model-driven approach enhances scalability, adaptability, and accuracy by allowing the system to dynamically adjust execution patterns as network configurations evolve, security policies are updated, or new compliance mandates are introduced. By automating the determination of execution sequencing, the system ensures that control enforcement remains consistent, efficient, and aligned with operational and regulatory requirements.

In some embodiments, the system may determine the first entry point to the computer network for the first control based on the first input characteristic for the first control by comparing a plurality of input characteristics for a plurality of network components activated by the first control to determine dependencies between the plurality of network components and using the dependencies to determine the first entry point. For example, the process begins when the system identifies a plurality of network components that are activated by the first control. Each of these components has distinct input characteristics that define how they process and respond to incoming data, security policies, or operational commands. These input characteristics may include authentication requests, encryption protocols, network packet validations, access control rules, and API call parameters. Next, the system compares the plurality of input characteristics across these components to determine the dependencies between them. By analyzing how one component's output serves as another component's input, the system constructs a dependency map that outlines the sequence in which network components process control execution data. For example, if an Identity and Access Management (IAM) system generates an authentication token, which is then used by a firewall to validate access permissions, the system establishes a dependency where the firewall depends on the IAM system's authentication process before enforcing security policies. Using these dependencies, the system identifies the first entry point by determining which component in the dependency sequence is the first to receive an external input that initiates the control process. If an API gateway receives an incoming request, validates security headers, and forwards the request to an internal application firewall, the system recognizes that the API gateway is the first entry point since it is the initial component processing data before any security enforcement occurs. Similarly, if the control enforces transaction monitoring in a financial network, the system may determine that a payment processing system is the first entry point because it receives raw transaction data before it is analyzed for fraud detection or compliance validation. By structuring entry point determination around component dependencies rather than static network attributes, the system ensures that execution patterns remain adaptive and scalable. This method allows for real-time monitoring, automated compliance enforcement, and proactive security threat mitigation, ensuring that control execution remains accurate, efficient, and aligned with evolving network configurations.

At step 406, process 400 (e.g., using one or more components described above) determines a first network component corresponding to a first input characteristic. For example, the system may determine a first network component corresponding to the first input characteristic. The system may identify input characteristics across multiple components, map data flow dependencies, and isolate the component responsible for initiating control execution. The system begins by retrieving and analyzing the first input characteristic, which defines the type of data, event, or trigger that initiates the control. This input characteristic may include authentication credentials, network packets, API requests, security tokens, data validation checks, or transaction records. By examining this characteristic, the system determines what type of component is responsible for receiving, processing, or generating a response based on this input.

In some embodiments, the system may determine the first network component corresponds to the first input characteristic by determining a first function performed by the first network component and determining that the first function corresponds to the first input characteristic. To achieve this, the system retrieves functional metadata about network components, including their capabilities, processing logic, and operational roles. The system then evaluates the first function performed by each network component to determine whether it is responsible for receiving, validating, modifying, or enforcing the control related to the first input characteristic. For example, if the first input characteristic is an authentication request, the system checks whether a component's first function is related to identity verification, credential validation, or security token generation. If the function corresponds to validating user credentials against a database or enforcing multi-factor authentication (MFA), the system determines that an Identity and Access Management (IAM) service is the first network component. Similarly, if the first input characteristic is a network packet requiring inspection, the system evaluates which component performs the first function related to packet filtering, deep packet inspection (DPI), or intrusion detection. If a firewall applies predefined security rules before forwarding packets, the system determines that the firewall is the first network component because its function directly corresponds to the input characteristic of network packet filtering. The system validates this mapping process by analyzing real-time network logs, historical data flow records, and dependency models to confirm that the identified component consistently processes the first input characteristic in the expected manner. If discrepancies exist, the system may refine the analysis by checking alternate components with similar functions or tracing execution sequences to ensure accuracy. By using a function-driven approach to determine component-input alignment, the system ensures that control execution is structured, predictable, and adaptable across various network environments. This methodology allows for seamless integration of security controls, compliance automation, and operational monitoring, making control enforcement scalable, resilient, and optimized for evolving network architectures.

In some embodiments, the system may determine the first network component corresponds to the first input characteristic by determining a first device class for the first network component and determining that the first device class corresponds to the first input characteristic. For example, A system determines that the first network component corresponds to the first input characteristic by identifying the device class of the component and ensuring that this classification aligns with the processing requirements of the input characteristic. This approach allows the system to categorize network components based on their functional roles, ensuring that control execution follows a structured and predictable sequence across the network infrastructure. The process begins with the system retrieving the first input characteristic, which defines the type of data, request, or event that initiates control execution. This characteristic could include user authentication credentials, API requests, network packets, encryption keys, or compliance validation data. To process this input correctly, the system must identify which class of network device is best suited to handle it.

Next, the system determines the first device class for the first network component by analyzing the functional attributes, role, and operational scope of each component in the network. Device classes may include: Access Control Devices (e.g., Identity and Access Management (IAM) systems, authentication servers); Security Appliances (e.g., firewalls, intrusion detection/prevention systems (IDS/IPS)); Traffic Routing Devices (e.g., routers, load balancers, SD-WAN gateways); and Data Processing Systems (e.g., API gateways, application servers, cloud storage services).

Once the system classifies the first network component into a device class, it determines whether this classification corresponds to the expected processing behavior of the first input characteristic. If the first input characteristic is a user authentication request, the system checks whether the first device class is an Access Control Device (e.g., IAM system or authentication server). If so, it confirms that this network component is the first to process the authentication input. If the first input characteristic is an inbound network packet requiring security validation, the system determines whether the first device class belongs to Security Appliances (e.g., firewalls or IDS/IPS). If a firewall performs packet inspection as its primary function, the system recognizes it as the first network component responsible for processing the input characteristic. If the first input characteristic involves API request validation, the system checks whether the first device class is a Data Processing System, such as an API gateway. If an API gateway handles request authentication, rate limiting, and security checks, it is identified as the first network component. By mapping device classes to input characteristics, the system ensures a structured, scalable, and adaptable execution pattern that supports security enforcement, compliance validation, and operational monitoring. This classification-driven approach simplifies network component identification, making it easier to integrate new components, standardize security policies, and automate control execution workflows across heterogeneous network environments.

At step 408, process 400 (e.g., using one or more components described above) determines a second input characteristic for the control. For example, the system may determine a second input characteristic for the first control.

At step 410, process 400 (e.g., using one or more components described above) selects a second network component based on the second input characteristic. For example, the system may select a second network component from a plurality of network components based on the second network component corresponding to the second input characteristic. The system may select a second network component from a plurality of network components by identifying the second input characteristic and determining which component is responsible for processing it. This selection process ensures that control execution follows a logical sequence, where each network component processes data according to its functional role, device classification, and operational dependencies within the network. The system begins by analyzing the plurality of network components that could potentially process the second input characteristic. Each network component has specific functions, security policies, and data-handling capabilities, making it necessary for the system to determine which one is best suited for processing the next stage of the execution pattern. To make this determination, the system retrieves the second input characteristic, which represents a data point, security validation, compliance requirement, or operational trigger that must be processed after the first input characteristic. The system then matches this characteristic to the expected functional behavior of network components in the execution sequence.

At step 412, process 400 (e.g., using one or more components described above) determines a hierarchical pathway for the execution pattern. For example, the system may determine a hierarchical execution pathway between the first network component and the second network component. The system may system determines a hierarchical execution pathway between the first network component and the second network component by analyzing data flow dependencies, execution rules, security policies, and functional relationships between components within the network. This hierarchical pathway ensures that control execution follows a structured sequence, aligning with security enforcement, compliance validation, and operational workflow requirements. The process begins when the system establishes the first network component, which corresponds to the first input characteristic and serves as the initial processing point for the control execution. The system then identifies the second network component, which corresponds to the second input characteristic and is responsible for processing the next stage of the execution sequence. To construct the hierarchical execution pathway, the system evaluates functional dependencies between these components. It determines how the output of the first network component serves as an input for the second network component, creating a cause-and-effect relationship in the execution flow. For example, if the first network component is an authentication server that verifies user credentials, and the second network component is a firewall enforcing access control, the system identifies that the firewall depends on authentication responses before allowing or denying network access. This dependency forms the basis of the hierarchical execution pathway. Next, the system maps the execution pathway by analyzing historical execution logs, real-time data flow telemetry, and system configuration records. If the control execution follows multi-layered security policies or compliance rules, the system may introduce intermediate components into the hierarchy, such as an intrusion detection system (IDS) that processes security alerts before passing data to a firewall. The system assigns execution priorities and rule-based conditions, ensuring that each component in the pathway executes only after its dependencies are satisfied.

Additionally, or alternatively, the system may use graph-based modeling, dependency resolution algorithms, or AI-driven analytics to dynamically adjust the hierarchical pathway as network configurations evolve. If new security measures or compliance mandates are introduced, the system automatically updates the execution sequence, ensuring that the hierarchical pathway remains adaptive and scalable. By determining the hierarchical execution pathway, the system ensures that control enforcement is predictable, scalable, and aligned with organizational security frameworks. This methodology allows for seamless integration of new network components, automated anomaly detection, and optimized compliance monitoring, ultimately enhancing the efficiency and security of network control execution.

In some embodiments, the system may determine the hierarchical execution pathway between the first network component and the second network component by inputting the first input characteristic and the second input characteristic into a first model to determine an output indicating an order at which the input characteristics are generated and using the output to determine a hierarchical execution pathway. For example, the system may determine the hierarchical execution pathway between the first network component and the second network component by leveraging a model-driven approach that analyzes the sequence of input characteristic generation to establish execution dependencies. This ensures that control enforcement follows a structured, predictable, and adaptable execution pattern. The process begins with the system identifying the first input characteristic and the second input characteristic, each representing a data point, security validation, compliance check, or operational event within the network. Instead of manually mapping execution dependencies, the system inputs these characteristics into a first model, which evaluates their generation sequence based on network activity logs, historical control execution patterns, and real-time operational data. The first model processes these input characteristics and determines an output that indicates the order in which the input characteristics are generated. This model may use graph-based dependency resolution, rule-based logic, or AI-driven sequence prediction to establish whether the first input characteristic precedes the second and whether additional intermediary steps exist between them.

For example, if the first input characteristic is a user authentication request, and the second input characteristic is an access control verification, the model may analyze system dependencies and determine that: an identity provider (first network component) processes authentication requests first; only after authentication succeeds does the firewall (second network component) evaluate access control permissions; and if authentication fails, the firewall never receives the request, establishing a strict execution dependency.

Once the model output establishes this sequence, the system uses it to determine the hierarchical execution pathway between the first and second network components. The execution pathway is then structured to ensure that the first network component processes the first input characteristic before passing outputs to the second network component. Dependencies between control functions may be determined by the system, ensuring that each step occurs in the correct order. Anomalies, deviations, or execution failures can be detected by the system by monitoring whether the hierarchical execution sequence is properly followed. By structuring the execution pathway based on data-driven modeling rather than static component attributes, the system enhances control execution consistency, compliance monitoring, and security enforcement. Additionally, this methodology allows for dynamic adaptability, meaning that if network configurations change or new security policies are introduced, the system can automatically update execution sequences based on real-time model re-evaluations.

In some embodiments, the system may determine the hierarchical execution pathway between the first network component and the second network component by determining a first sub-execution pattern for the first execution pattern and determining a second sub-execution pattern for the first execution pattern. For example, the system determines the hierarchical execution pathway between the first network component and the second network component by breaking down the first execution pattern into structured sub-execution patterns, ensuring that the control flow is organized, modular, and adaptable. This approach allows the system to define detailed execution sequences within a broader control enforcement framework, improving observability, compliance tracking, and operational efficiency. The process begins with the system establishing the first execution pattern, which represents the overall sequence of operations required to enforce a given control across the network. Within this pattern, different components perform distinct functions, interacting based on data dependencies, security policies, and operational workflows. Instead of treating the execution pattern as a single monolithic sequence, the system decomposes it into sub-execution patterns, each representing a localized execution process within the broader control framework. To determine the hierarchical execution pathway, the system first identifies the first sub-execution pattern, which encompasses the processing logic between the first network component and its immediate dependencies. This pattern defines how the first input characteristic propagates through initial network layers, including validation, authentication, or data preprocessing. Similarly, the system determines the second sub-execution pattern, which governs how the second network component processes its respective inputs before forwarding outputs downstream. This pattern defines how the second input characteristic is handled, ensuring that execution dependencies are logically structured. Once both sub-execution patterns are established, the system integrates them into the hierarchical execution pathway, ensuring that the second sub-execution pattern only initiates once the first sub-execution pattern has completed its required operations. This structure enforces dependency-driven execution sequencing, preventing out-of-order processing, security gaps, or policy violations.

In some embodiments, the system may determine the hierarchical execution pathway between the first network component and the second network component by determining a data transformation between the first input characteristic and the second input characteristic and determining the data transformation corresponds to the first network component system determines the hierarchical execution pathway between the first network component and the second network component by analyzing how data transforms as it moves through the execution sequence. This approach ensures that control execution follows a logical, structured process, where data dependencies and transformations dictate how network components interact. By identifying the data transformation between the first input characteristic and the second input characteristic, the system establishes how data is processed, modified, or validated, helping define execution dependencies between components. The process begins with the system identifying the first input characteristic, which represents the initial data point, security event, compliance check, or operational trigger entering the network. The system then tracks how this data is transformed, enriched, or modified before generating the second input characteristic, which serves as the processing trigger for the next network component.

To establish the execution pathway, the system determines the data transformation that occurs between these two characteristics. This transformation may include encryption, authentication token generation, network packet filtering, anomaly detection, access control decisions, or compliance validation. For example, if the first input characteristic is a user login request, and the second input characteristic is an access control validation event, the system may identify that the data transformation involves credential verification, multi-factor authentication, and token generation. If the first input characteristic is a raw network packet, and the second input characteristic is an intrusion detection alert, the data transformation may include deep packet inspection (DPI), rule-based threat analysis, and security event logging.

Once the system identifies the data transformation, it determines which network component is responsible for performing it. This analysis ensures that the first network component is the one that transforms the initial data before passing it to the second network component. For example, if an Identity and Access Management (IAM) system verifies user credentials and generates an authentication token, the system confirms that the IAM system is the first network component responsible for transforming the login request before passing it to the next security layer. If a firewall inspects incoming network traffic and classifies it for risk analysis, the system determines that the firewall is the first network component in the execution pathway before an Intrusion Detection System (IDS) processes threat intelligence. By using data transformations as the basis for execution sequencing, the system ensures that control enforcement is data-driven, scalable, and adaptable to changes in security policies or compliance mandates. This structured approach allows the system to track data lineage, enforce execution dependencies, and optimize security operations, ensuring that network components interact in a predictable, auditable, and efficient manner within the hierarchical execution pathway.

In some embodiments, the system may determine the hierarchical execution pathway between the first network component and the second network component by determining a workflow for a first operation governed by the first control and determining the workflow corresponds to the first input characteristic and the second input characteristic. For example, to define the hierarchical execution pathway, the system first matches the workflow to the first input characteristic, identifying where the execution process begins within the network. This involves detecting which network component first receives, processes, or generates data that triggers the control operation. For example, if the control enforces multi-factor authentication (MFA), the system may determine that the first input characteristic is a login request, which the workflow associates with an Identity and Access Management (IAM) system as the first network component. Next, the system determines how the workflow transitions from the first input characteristic to the second input characteristic, which represents the next stage of processing in the execution sequence. The second input characteristic often results from a decision, validation, or transformation occurring in the first network component. For example, in an MFA workflow, the second input characteristic could be the generation of an authentication token after the user has successfully passed identity verification. The workflow would define that this token must be validated by a firewall or access control system before granting access, establishing the second network component in the execution pathway.

In some embodiments, the system may determine the first execution pattern determining a first exit point to the computer network for the first control based on a third input characteristic for the first control and determining a third network routing component from the plurality of network components based on the third network routing component corresponding to the third input characteristic. For example, the system determines the first execution pattern by identifying a first exit point in the computer network for the first control, ensuring that data, security policies, and operational workflows align with the intended execution sequence. This process involves analyzing the third input characteristic associated with the control, which defines how data or transactions are processed, validated, and routed before leaving the network. The system also identifies a third network routing component from a plurality of network components, ensuring that it corresponds to the third input characteristic and serves as the appropriate exit point in the execution pattern. The process begins when the system retrieves the third input characteristic, which represents a key operational condition, such as data encryption verification, final access control validation, compliance confirmation, or outbound traffic routing decisions. This characteristic determines how the network processes and approves outgoing data, ensuring that security and governance controls are properly enforced before data leaves the internal environment.

Next, the system scans the plurality of network components to identify routing components responsible for handling outbound traffic, external API calls, remote access, or cross-network transactions. Common network routing components include firewalls, which enforce security policies and filter outbound traffic, API gateways, which regulate external service interactions, and/or load balancers, which distribute outbound requests across external destinations.

To determine the first exit point, the system matches the third input characteristic to a network routing component that processes the relevant type of data or security condition. For example, if the third input characteristic involves validating encryption before data transmission, the system may determine that a TLS termination proxy or API gateway is the appropriate third network routing component, ensuring that data meets encryption standards before leaving the network. If the third input characteristic relates to traffic filtering for compliance monitoring, the system may select a firewall or Secure Web Gateway (SWG) as the third network routing component to apply security policies and regulatory checks before allowing outbound connections. If the third input characteristic involves routing internet-bound requests, the system may determine that an egress router, SD-WAN gateway, or proxy server serves as the first exit point, ensuring that external communication follows predefined routing rules. Once the third network routing component is identified, the system integrates it into the first execution pattern, mapping how the first and second network components interact with the third component to ensure a structured, policy-driven data flow.

In some embodiments, the system may determine, a first status for the first control, based on comparing a first output characteristic of the first network component to the first execution pattern and generate for display, on a user interface, the first status. For example, the system may determine a first status for the first control by comparing a first output characteristic of the first network component to the first execution pattern, ensuring that the control is functioning as expected within the network. This process allows the system to validate compliance, detect anomalies, enforce security policies, and optimize operational efficiency by continuously monitoring the execution of the control. Once the status is determined, the system generates and displays the status on a user interface, providing real-time visibility into control execution. The process begins with the system retrieving the first output characteristic from the first network component, which represents the result of processing the first input characteristic. This output characteristic could include authentication logs, packet filtering decisions, transaction validation results, encryption status, or compliance verification data. The system then retrieves the first execution pattern, which defines the expected sequence of control execution, dependencies between network components, and conditions for successful enforcement. Next, the system performs a comparative analysis, checking whether the first output characteristic aligns with the expected behavior defined in the first execution pattern. This comparison may involve matching security enforcement results (e.g., verifying that an authentication request was properly validated), checking data transformation accuracy (e.g., ensuring an API gateway correctly encrypted a request), validating compliance conditions (e.g., confirming that firewall rules applied appropriate access controls), and/or analyzing performance metrics (e.g., measuring latency, processing time, or failure rates in control execution).

For example, if the first output characteristic aligns with the expected execution pattern, the system assigns a first status indicating that the control is functioning correctly (e.g., “Control Executed Successfully” or “Compliant”). However, if deviations, errors, or security gaps are detected, the system generates an alert or failure status (e.g., “Authentication Failed”, “Unauthorized Access Detected”, or “Non-Compliant Configuration”). Once the first status is determined, the system generates a visual representation for display on a user interface, ensuring that network administrators, compliance officers, or security teams can quickly assess the control's execution state. The user interface may include real-time dashboards displaying status indicators (e.g., green for success, red for failure), detailed logs providing execution insights and detected anomalies, graphical reports illustrating control execution flow and dependencies, and/or automated alerts or recommendations for remediation actions if failures are detected. By systematically comparing real-world execution characteristics to expected control behaviors, the system ensures that control monitoring remains transparent, efficient, and adaptive. This methodology enables proactive security enforcement, real-time compliance validation, and automated troubleshooting, helping organizations maintain secure, compliant, and well-governed network operations.

FIG. 5 shows a flowchart of the steps involved in implementing control hub component layers by for monitoring controls, in accordance with one or more embodiments. For example, the system may use process 500 (e.g., as implemented on one or more system components described above) in order to implement control hub component layers by for monitoring controls across diverse network ecosystems

At step 502, process 500 (e.g., using one or more components described above) retrieve an execution pattern corresponding to a control. For example, the system may retrieve a first execution pattern corresponding to a first control, wherein the first execution pattern comprises a hierarchical execution pathway that is predetermined for the first control by a control hub orchestration layer. The system retrieves a first execution pattern corresponding to a first control by accessing a predefined hierarchical execution pathway that has been established by a control hub orchestration layer. This process ensures that control execution follows a structured, policy-driven sequence where network components interact in a predefined order to enforce security, compliance, and operational requirements. The retrieval process begins when the system receives a request to monitor, validate, or execute the first control. This request can be triggered by a user input, automated compliance check, security policy enforcement, or real-time event detection. The system then queries the control hub orchestration layer, which functions as a centralized governance engine that manages execution pathways for different controls across the network.

The control hub orchestration layer maintains a database of execution patterns, each corresponding to a specific control type, regulatory framework, or operational function. These execution patterns are predefined based on best practices, compliance requirements, security policies, and past execution analytics. Each execution pattern may include a hierarchical execution pathway, which defines the order in which network components interact during control execution, defined input and output characteristics for each component to ensure consistent data flow and security validation, dependency mappings, which specify how one component's output serves as another component's input, ensuring logical execution sequencing, and/or error-handling procedures, defining how the system should respond to failures, deviations, or security anomalies during execution.

Once the system retrieves the first execution pattern, it analyzes the hierarchical execution pathway to determine how the first control should be executed. For example, if the control involves user authentication and access validation, the hierarchical pathway may include an Identity and Access Management (IAM) system as the first network component, responsible for processing login credentials and generating authentication tokens, a firewall as the second network component, which validates the authentication token before allowing access, a secure web gateway (SWG) as the third network component, which enforces data loss prevention (DLP) rules for outbound traffic. By retrieving and applying this hierarchical execution pathway, the system ensures that control execution remains structured, auditable, and aligned with security and compliance mandates. If real-time monitoring detects anomalies or deviations, the system can dynamically adjust execution by querying the control hub for updated execution pathways or triggering automated remediation processes.

In some embodiments, the system may retrieve the first execution pattern corresponding to the first control by receiving a first request to implement a first operation across a computer network, receiving a second request to monitor the first control across the computer network, and determining to retrieve the first execution pattern in response to the second request. For example, the system retrieves the first execution pattern corresponding to the first control by responding to requests for both control implementation and monitoring, ensuring that control execution follows a structured and auditable sequence across a computer network. This process involves receiving and processing multiple requests, dynamically retrieving predefined execution pathways, and ensuring that the control functions correctly within the network's operational and security framework. The process begins when the system receives a first request to implement a first operation across the computer network. This request may originate from a user action, an automated compliance enforcement mechanism, a security monitoring tool, or a scheduled policy execution. The request specifies that the system must execute a specific control, such as user authentication validation, transaction security enforcement, firewall rule application, or regulatory compliance auditing. Upon receiving this request, the system identifies the associated control and determines that execution will require a structured, hierarchical execution pattern to ensure consistent enforcement. Subsequently, the system receives a second request to monitor the first control across the network, indicating that the execution of the control must be tracked, validated, and evaluated for compliance, security, or performance purposes. This request may be triggered by a network administrator, an automated anomaly detection system, or a regulatory compliance framework that requires ongoing validation of control effectiveness. In response to the second request, the system determines that retrieving the first execution pattern is necessary to properly monitor and validate control execution. Since the first execution pattern is a predefined hierarchical structure managed by the control hub orchestration layer, the system queries the control hub to retrieve the execution pattern associated with the first control. By retrieving and applying the first execution pattern, the system ensures that the monitoring process is accurate and aligned with the predefined control enforcement sequence. If deviations, anomalies, or security threats are detected, the system can automatically trigger remediation actions, update security policies, or adjust execution parameters to maintain control effectiveness.

In some embodiments, the system may determine the first execution pattern by inputting the first input characteristic and the second input characteristic into a first model to determine an output indicating an order at which the first input characteristic and the second input characteristic are generated and using the output to determine a hierarchical execution pathway. For example, the system determines the first execution pattern by leveraging a model-driven approach to analyze the sequence of input characteristic generation, ensuring that control execution follows a structured and logical order. By inputting the first input characteristic and the second input characteristic into a first model, the system can generate an output that defines the order in which these characteristics are produced, allowing it to establish a hierarchical execution pathway that governs how network components interact. The process begins with the system identifying the first input characteristic, which represents the initial trigger for control execution, such as an authentication request, network packet, compliance check, or security validation event. It then retrieves the second input characteristic, which serves as a dependent data point or operational requirement that must be processed after the first characteristic. The system must determine the correct execution sequence to ensure that control enforcement aligns with security, compliance, and operational policies. To establish this order, the system inputs both characteristics into a first model, which may analyze data dependencies to determine how the first characteristic influences the second, component functions to identify which network elements process each characteristic, execution constraints to enforce compliance and security rules, and/or historical control execution data to recognize established patterns in similar scenarios.

The model then produces an output that specifies the order in which the input characteristics are generated. Using this output, the system establishes the hierarchical execution pathway, ensuring that network components interact in a defined order based on dependencies, data flows from one component to the next only after the required conditions are met, and/or security and compliance controls are applied at the correct stages in execution.

At step 504, process 500 (e.g., using one or more components described above) determines a first network component and a second network component corresponding to the first control based on the execution pattern. For example, the system may determine, at a control hub component layer, a first network component and a second network component corresponding to the first control based on the hierarchical execution pathway for the first execution pattern. For example, the system determines, at a control hub component layer, a first network component and a second network component corresponding to the first control by referencing the hierarchical execution pathway within the first execution pattern. This structured approach ensures that control execution follows a logical, policy-driven sequence, allowing the system to enforce security, compliance, and operational governance efficiently. The process begins when the control hub component layer retrieves the first execution pattern, which defines the structured sequence of network components that interact to enforce and validate the first control. The execution pattern establishes a hierarchical execution pathway, mapping input-output relationships, data transformations, and security enforcement stages across the network. To determine the first network component, the system examines the entry point in the hierarchical execution pathway—the component responsible for processing the first input characteristic. This network component is typically one that initially receives a request, packet, authentication token, or transaction related to the control.

In some embodiments, the system may determine the first network component and the second network component corresponding to the first control based on the hierarchical execution pathway for the first execution pattern by determining a workflow for implementing a first operation across a computer network, and determining an order of network components used to implement the first operation based on the first execution pattern. For example, the system determines the first network component and the second network component corresponding to the first control based on the hierarchical execution pathway for the first execution pattern by analyzing the workflow required to implement a first operation across the computer network. This structured approach ensures that control execution is efficient, policy-compliant, and logically sequenced, enabling the system to identify dependencies between network components and enforce security, compliance, and operational rules. The process begins when the system identifies the first operation, which represents the specific task governed by the first control. This operation could involve user authentication, network traffic filtering, data encryption, API validation, financial transaction monitoring, or regulatory compliance enforcement. The system then retrieves the first execution pattern, which provides a structured sequence defining how network components interact to implement the control. To determine the first network component, the system evaluates the workflow associated with the first operation and identifies the entry point—the component responsible for processing the first input characteristic. Once the system determines the first network component, it then analyzes the hierarchical execution pathway to establish the order of additional network components involved in implementing the operation. This process ensures that each subsequent component follows a logical execution sequence, with the output of one component serving as the input for the next. The system identifies the second network component as the next component in the hierarchical execution pathway, meaning it processes the results of the first component's operation.

At step 506, process 500 (e.g., using one or more components described above) retrieves a first input characteristic for the second network component. For example, the system may retrieve a first input characteristic and a first input metric for the second network component. The system may retrieve a first input characteristic and a first input metric for the second network component based on the stored execution pattern for the control by analyzing predefined control dependencies, hierarchical execution pathways, and expected data transformations within the network. This structured retrieval process ensures that the second network component receives accurate input parameters, allowing it to properly execute its function in the control enforcement sequence. The process begins when the system accesses the stored execution pattern for the control, which defines how network components interact, the sequence in which they process data, and the required characteristics for each stage of execution. This execution pattern is typically maintained by a control hub orchestration layer, ensuring that all control operations follow a structured and consistent approach. To retrieve the first input characteristic for the second network component, the system first identifies the output characteristic of the first network component, since control execution follows a dependency chain where the output of one component serves as the input for the next. By analyzing the execution pattern, the system determines what type of data, security validation, or operational result the first network component generates that must be processed by the second network component. Once the first input characteristic is determined, the system retrieves the first input metric, which provides quantifiable parameters for how the second network component should process the input. These metrics may include authentication success rate thresholds for IAM systems, latency limits for API requests, security risk scores for firewall packet filtering, and/or data integrity checksums for encrypted transactions. By aligning input characteristics and metrics with the stored execution pattern, the system ensures that the second network component receives validated, structured input data, preventing execution errors, security gaps, or compliance violations. This retrieval process supports adaptive control monitoring, automated compliance validation, and scalable network governance, ensuring that control execution remains efficient, auditable, and aligned with security policies.

In some embodiments, the system may retrieve the first input characteristic and the first input metric for the second network component by determining a first value range of inputs for the second network component and determining the first input characteristic based on the first value range. For example, the system retrieves the first input characteristic and the first input metric for the second network component by first determining a first value range of inputs that the second network component is designed to process. This structured approach ensures that the system identifies valid, expected inputs for the second network component, aligning with its operational role, security enforcement, and compliance requirements within the network. The process begins when the system analyzes the execution pattern and identifies the second network component as the next step in the control execution sequence. The system then evaluates the expected input parameters for this component by determining a first value range of inputs-a predefined set of data types, security parameters, operational constraints, or compliance thresholds that dictate what constitutes a valid input for the second network component. These value ranges are typically predefined based on historical execution data, security policies, and control enforcement rules. For example, if the second network component is a firewall, the system may determine that its valid first value range of inputs includes source IP addresses within an authorized subnet, encrypted packets using specific TLS versions, and authenticated session tokens. If the second network component is an API security gateway, the system may determine that its first value range includes API requests formatted in JSON, HTTP headers containing authentication tokens, and request payload sizes within defined limits. Once the system determines this first value range, it then identifies the first input characteristic as the specific data type or security validation parameter that matches this expected range. The first input characteristic must fall within the allowable constraints defined for the second network component to ensure successful processing.

In some embodiments, the system may retrieve the first input characteristic and the first input metric for the second network component by determining a unit of measure for values for the second network component and determining the first input metric based on the unit of measure for values. For example, t system retrieves the first input characteristic and the first input metric for the second network component by first determining a unit of measure that defines the expected format, scale, or quantifiable parameters for values processed by the second network component.

This ensures that input data is standardized, properly formatted, and aligned with the operational requirements of the component, preventing errors and inconsistencies in control execution. The process begins when the system identifies the second network component in the execution pattern and analyzes the type of data it processes, enforces, or validates. Since different network components handle varied types of input values, the system must determine the unit of measure for those values to ensure they conform to expected operational standards. Units of measure may include time-based metrics (e.g., request latency in milliseconds, session timeouts in seconds), data volume metrics (e.g., packet size in bytes, request payload size in kilobytes), security scoring metrics (e.g., risk score percentages, compliance violation thresholds), and/or financial thresholds (e.g., transaction amounts in currency units, fraud detection scores). Once the system determines the unit of measure, it then retrieves the first input metric, which defines a quantifiable threshold, acceptable range, or predefined standard for how the second network component processes incoming data. The first input metric ensures that control execution is consistent, measurable, and aligned with policy enforcement rules.

For example, if the second network component is a firewall, and the unit of measure is packet size (bytes), the system may retrieve the first input metric as a maximum packet size limit of 1500 bytes, ensuring that large packets are either fragmented or rejected based on policy. If the second network component is an API gateway, and the unit of measure is requesting response time (milliseconds), the system may retrieve the first input metric as a response time threshold of 500 ms, ensuring API calls that exceed this limit trigger performance alerts. If the second network component is a fraud detection engine, and the unit of measure is transaction amount (currency), the system may retrieve the first input metric as a high-risk transaction threshold of $10,000, meaning all transactions exceeding this limit are flagged for review.

In some embodiments, the system may retrieve the first input characteristic and the first input metric for the second network component by determining a first threshold variation for inputs to the second network component and determining the first input characteristic based on the first threshold variation. For example, the system retrieves the first input characteristic and the first input metric for the second network component by determining a first threshold variation for inputs that the second network component is designed to process. This approach ensures that input values remain within acceptable operational ranges, preventing errors, security risks, or compliance violations while maintaining control execution integrity. The process begins with the system analyzing the execution pattern and identifying the second network component, which plays a role in validating, transforming, or enforcing policies on incoming data. To ensure proper execution, the system must determine the first threshold variation, which defines acceptable deviations or ranges for inputs before they are flagged as potential anomalies or policy violations. This threshold variation allows for flexibility in execution while still maintaining control consistency. Once the system establishes the first threshold variation, it retrieves the first input characteristic by identifying an expected value or format that falls within the acceptable range. For example, if the second network component is a firewall, and the threshold variation for packet size is +10% from a baseline of 1500 bytes, the system retrieves the first input characteristic as an incoming packet with a size range of 1350-1650 bytes to allow for network fluctuations while still enforcing security policies. If the second network component is an API gateway, and the threshold variation for API response times is 20% from an expected 500 ms, the system retrieves the first input characteristic as API requests with a response time range of 400-600 ms, ensuring that latency remains within an acceptable operational range. If the second network component is a financial fraud detection engine, and the threshold variation for high-risk transactions is +5% from a $10,000 baseline, the system retrieves the first input characteristic as transactions in the $9,500-$10,500 range, allowing slight variations in normal transaction patterns while still triggering alerts for potential fraud.

In some embodiments, the system may retrieve the first input characteristic and the first input metric for the second network component by determining a first input type for the second network component and determining the first input metric based on the first input type. For example, the system retrieves the first input characteristic and the first input metric for the second network component by first determining the first input type, which categorizes the nature of the data, signal, or event that the second network component is designed to process. This classification ensures that the system retrieves and applies the correct metrics, maintaining control execution integrity, operational efficiency, and security compliance. The process begins when the system analyzes the execution pattern and identifies the second network component, which plays a specific role in processing, validating, transforming, or enforcing policies on incoming data. To ensure that the correct input characteristic is retrieved, the system must determine the first input type, which could be one of several categories, such as Authentication Data (e.g., login credentials, session tokens), Network Traffic (e.g., packet headers, payload data), API Requests (e.g., HTTP methods, request payloads), Financial Transactions (e.g., payment amounts, risk scores), and/or Security Events (e.g., intrusion detection alerts, anomaly reports). Once the first input type is identified, the system then retrieves the first input metric, which provides a quantifiable threshold, validation rule, or predefined standard that defines how the second network component processes the input. The first input metric ensures that execution follows expected policies, security enforcement rules, and performance benchmarks.

For example, if the first input type is authentication data, and the second network component is an Identity and Access Management (IAM) system, the system may retrieve the first input metric as a multi-factor authentication success rate of 95%, ensuring that authentication requests meet security compliance standards. If the first input type is network traffic, and the second network component is a firewall, the system may retrieve the first input metric as a packet rate threshold of 10,000 packets per second, ensuring that excessive traffic is flagged for further inspection. If the first input type is an API request, and the second network component is an API gateway, the system may retrieve the first input metric as a request size limit of 1 MB, ensuring that overly large requests are rejected to prevent denial-of-service (DoS) attacks. If the first input type is a financial transaction, and the second network component is a fraud detection engine, the system may retrieve the first input metric as a risk score threshold of 80%, meaning that any transaction with a fraud probability above this level triggers an alert for manual review. By structuring the retrieval of the first input characteristic and first input metric based on the first input type, the system ensures that the second network component receives, interprets, and processes inputs efficiently, maintaining control execution accuracy. This methodology enhances real-time monitoring, compliance enforcement, and automated risk detection, allowing network components to operate seamlessly within a predefined security and operational framework.

In some embodiments, the system may retrieve the first input characteristic and the first input metric for the second network component by determining a data source and/or data type for the second network component and determining the first input characteristic and the first input metric based on the data source and/or data type. For example, the system retrieves the first input characteristic and the first input metric for the second network component by first determining the data source and/or data type that the second network component is designed to process. This approach ensures that the system aligns input retrieval with data flow dependencies, security policies, and operational requirements, allowing the second network component to function accurately within the control execution pattern. The process begins when the system identifies the second network component based on the hierarchical execution pathway in the stored execution pattern. To retrieve the correct input, the system determines the data source—the origin of the information the second network component processes. The data source could be authentication services (e.g., Identity and Access Management (IAM) systems, Single Sign-On (SSO) providers), network traffic logs (e.g., firewalls, intrusion detection systems (IDS), VPN gateways), application-layer data (e.g., API gateways, database query logs), financial transaction records (e.g., payment processors, fraud detection systems), and/or security event logs (e.g., Security Information and Event Management (SIEM) platforms).

After determining the data source, the system identifies the data type that the second network component expects. The data type could be user authentication tokens (e.g., OAuth tokens, JWTs), network packets and headers (e.g., IP addresses, TCP flags), structured database queries (e.g., SQL commands, NoSQL JSON objects), transaction amounts and metadata (e.g., payment history, risk scores), and/or security alert logs (e.g., IDS rule violations, SIEM correlation alerts). Once the data source and data type are determined, the system retrieves the first input characteristic, which represents the specific data element required for processing. The system then retrieves the first input metric, which provides a quantifiable threshold, rule, or validation requirement to guide how the second network component should handle the input.

For example, if the data source is an authentication system and the data type is a session token, the system may retrieve the first input characteristic as a signed JWT (JSON Web Token) and the first input metric as a token expiration time of 15 minutes to enforce security policies. If the data source is a firewall and the data type is network packets, the system may retrieve the first input characteristic as an IP packet with a flagged anomaly and the first input metric as a packet drop rate threshold of 5% to identify potential DoS attacks. If the data source is a payment processor and the data type is financial transactions, the system may retrieve the first input characteristic as a transaction exceeding $10,000 and the first input metric as a fraud detection risk score above 80%, triggering further review. If the data source is a SIEM platform and the data type is a security event log, the system may retrieve the first input characteristic as an intrusion detection alert and the first input metric as an alert severity score above 7 (on a scale of 10) to prioritize critical threats.

At step 508, process 500 (e.g., using one or more components described above) detects a first output characteristic for the first network component. For example, the system may detect a first output characteristic for the first network component. The system detects a first output characteristic for the first network component by continuously monitoring and analyzing the data, security validations, or operational results generated by the component during control execution. This detection process ensures that the system accurately captures how the first network component processes incoming data, allowing it to determine whether control enforcement is proceeding as expected within the execution pattern. The process begins when the system identifies the first network component based on the hierarchical execution pathway in the execution pattern. The system then determines what kind of output characteristic should be expected based on the component's function, data processing role, and security enforcement responsibilities. The first output characteristic may include authentication responses (e.g., valid or invalid login attempts from an IAM system), packet filtering results (e.g., allowed or blocked packets from a firewall), API response data (e.g., successful or failed API call validations), transaction processing results (e.g., approved or flagged payments from a fraud detection engine), and/or security event logs (e.g., anomaly detection reports from an IDS or SIEM system). To detect the first output characteristic, the system actively monitors the output logs, event streams, or telemetry data from the first network component. This may involve querying system logs to retrieve processing outcomes (e.g., checking authentication success rates), capturing real-time data flows to analyze packet inspections, rule enforcement, or API request handling, applying anomaly detection models to detect irregular behavior in output patterns, and/or validating compliance adherence by comparing the output with predefined security policies. For example, if the first network component is an IAM system, the system may detect the first output characteristic as an authentication token issued for a verified user or a failed login attempt log for unauthorized access. If the first network component is a firewall, the system may detect the first output characteristic as a dropped packet due to an intrusion rule violation or a packet forwarding decision based on routing policies. If the first network component is a payment processor, the system may detect the first output characteristic as a transaction approval or rejection status based on fraud analysis. If the first network component is an API gateway, the system may detect the first output characteristic as an API response with an HTTP status code (e.g., 200 for success, 403 for unauthorized access, 500 for server errors). Once the first output characteristic is detected, the system can compare it with expected control execution patterns to determine whether the control is functioning correctly or if an anomaly, policy violation, or security risk is present. This detection process enables real-time monitoring, automated enforcement, and proactive response mechanisms, ensuring that network security, compliance, and operational controls remain intact.

At step 510, process 500 (e.g., using one or more components described above) compares the first input characteristic to the first output characteristic. For example, the system may compare, using the first input metric, the first input characteristic to the first output characteristic. The system compares the first input characteristic to the first output characteristic using the first input metric to determine whether the first network component has processed data as expected and whether control execution is proceeding correctly. This comparison ensures that the network control operates within predefined security, compliance, and operational parameters, helping to detect anomalies, validate execution integrity, and enforce policy adherence. The process begins with the system retrieving the first input characteristic, which represents the data, request, or security parameter that the first network component is expected to process. The system also retrieves the first output characteristic, which represents the resulting action, transformation, or enforcement decision generated by the first network component. To establish a meaningful comparison, the system applies the first input metric, which provides a quantifiable threshold, validation rule, or expected outcome to assess whether the output aligns with expectations. This comparison process can involve numerical threshold validation, where the system checks whether the output remains within an acceptable range of values, Boolean compliance checks, where the system verifies if the output meets binary conditions (e.g., pass/fail, allow/deny), and/or pattern matching and string validation, where the system compares expected and actual output formats (e.g., token structure, encryption format).

For example, if the first input characteristic is a user authentication request, the first input metric may define a 95% authentication success rate threshold, and the first output characteristic is the actual authentication result. The system compares the number of successful authentications to the threshold to determine whether authentication policies are being followed. If the first input characteristic is an API request with a defined response time metric (e.g., less than 500 ms), the system compares the first output characteristic (actual response time) to this threshold to determine whether API performance is within acceptable limits. If the first input characteristic is a network packet processed by a firewall, and the first input metric specifies that all traffic from a blacklisted IP range must be blocked, the system compares the first output characteristic (packet logs indicating allow/block decisions) to confirm whether the firewall has correctly enforced the rule. If the first input characteristic is a financial transaction flagged for fraud detection, and the first input metric specifies that transactions with a risk score above 80% should be blocked, the system compares the first output characteristic (whether the transaction was approved or denied) to determine compliance with fraud prevention policies. By applying the first input metric in the comparison process, the system ensures that control execution is accurate, aligned with security policies, and optimized for operational efficiency. If the system detects deviations, inconsistencies, or non-compliance, it can trigger alerts, remediation workflows, or automated policy adjustments, helping maintain real-time security enforcement, regulatory compliance, and system reliability.

At step 512, process 500 (e.g., using one or more components described above) determines, a status for the control, based on the comparison. For example, the system may determine, a first status for the first control, based on comparing the first input characteristic to the first output characteristic.

In some embodiments, the system may determine, the first status for the first control, based on comparing the first input characteristic to the first output characteristic by retrieving a difference between the first input characteristic to the first output characteristic and determining a normalization to apply to the difference based on the first execution pattern to determine the first status. For example, A system determines the first status for the first control by comparing the first input characteristic to the first output characteristic and analyzing any differences between them. This comparison allows the system to assess whether the control is functioning as expected within the first execution pattern and whether any deviations require remediation or escalation. To ensure that discrepancies are evaluated consistently, the system applies a normalization process to the detected difference, adjusting for variations based on predefined control execution parameters. The process begins when the system retrieves both the first input characteristic, representing the expected input data, request, or security condition, and the first output characteristic, which represents the actual result or enforcement decision produced by the first network component. To assess control effectiveness, the system calculates the difference between the first input characteristic and the first output characteristic, determining the magnitude and nature of any deviations. Next, the system determines a normalization method to apply to the difference, ensuring that the deviation is evaluated within the context of the control execution pattern. Normalization is necessary because expected variations, network conditions, and security policies may introduce minor discrepancies that should not necessarily trigger control failures. The system retrieves normalization rules from the first execution pattern, which defines acceptable deviations, tolerances, and policy enforcement parameters.

For example, if the first input characteristic is an authentication request, and the first output characteristic is a login failure, the system retrieves the difference (e.g., number of failed login attempts) and applies a normalization threshold (e.g., allowing up to three failed attempts before triggering an alert). The first status is then determined as “Compliant” if within the threshold or “Failed-Excessive Login Attempts” if exceeded. If the first input characteristic is an API request with an expected response time of 500 ms, and the first output characteristic is an actual response time of 520 ms, the system calculates a 20 ms difference and applies a latency normalization rule from the execution pattern (e.g., tolerating up to a 50 ms deviation). The first status is then determined as “Within Performance Threshold” or “Latency Warning” if exceeding predefined tolerance levels. If the first input characteristic is a firewall rule requiring the blocking of all unauthorized traffic from a specified region, and the first output characteristic indicates that 98% of those requests were blocked, the system calculates a 2% discrepancy and applies a security normalization threshold (e.g., a 99% blocking requirement). If the system determines that the difference is within an acceptable enforcement margin, it sets the first status as “Compliant”, whereas a larger deviation would trigger a “Partial Control Failure” status. If the first input characteristic is a flagged financial transaction for fraud detection, and the first output characteristic is an approval despite exceeding a fraud risk score threshold, the system detects a policy violation and applies fraud detection normalization rules (e.g., requiring manual review above a certain risk level). The first status is then set as “Fraud Review Required” or “Policy Violation” if the control was bypassed.

In some embodiments, the system may determine, the first status for the first control, based on comparing the first input characteristic to the first output characteristic by converting the first input characteristic and the second output characteristic into standardized values for the first execution pattern and using the standardized values to determine the first status. For example, a system determines the first status for the first control by converting the first input characteristic and the first output characteristic into standardized values based on the first execution pattern and then using these standardized values to assess whether the control executed as expected. This approach ensures that variations in data formats, measurement units, or system conditions do not introduce inconsistencies in control enforcement, allowing for a uniform, scalable evaluation of control effectiveness. The process begins when the system retrieves the first input characteristic, representing the expected data, request, or security condition, and the first output characteristic, which reflects the actual processing result from the first network component. Since these characteristics may be recorded in different units, formats, or scales, the system applies a standardization process to normalize the values within the context of the first execution pattern. To perform this standardization, the system determines the conversion rules defined in the execution pattern, which may include scaling factors (e.g., converting milliseconds to seconds for latency measurements), data normalization (e.g., mapping risk scores from different security tools to a unified 0-100 risk scale), threshold adjustments (e.g., aligning security event severities from different logging systems), and/or Boolean transformations (e.g., converting multiple status codes into a standardized pass/fail value).

For example, if the first input characteristic is an API request with an expected response time of 500 ms, and the first output characteristic is an actual response time of 0.5 seconds, the system converts both values into a standardized time unit (seconds) before comparison. It then determines the first status as “Within Threshold” if the response time falls within the acceptable range or “Performance Deviation” if it exceeds the predefined tolerance. If the first input characteristic is a network security rule requiring a minimum 95% packet filtering rate, and the first output characteristic is a raw count of blocked and allowed packets, the system standardizes the values into a percentage metric to determine compliance. The first status is then set as “Compliant” if the threshold is met or “Partial Enforcement Failure” if packet filtering is below expectations. If the first input characteristic is a fraud detection risk score from one system on a 0-10 scale, and the first output characteristic is a risk score from another system on a 0-100 scale, the system normalizes both scores onto a common percentage scale (0-100%) before comparison. It then assigns the first status as “High Risk-Flag for Review” if the standardized fraud probability exceeds a predefined risk threshold. If the first input characteristic is a security alert classification labeled as “Critical” in one system, but the first output characteristic is labeled as “Severity 1” in another system, the system maps both values to a unified severity scale and determines whether the response meets security policy expectations.

At step 514, process 500 (e.g., using one or more components described above) determines, a status for the control, based on the comparison. For example, the system may generate for display, on a user interface, the first status. The system generates the first status for display on a user interface by structuring and formatting the status data into a clear, actionable, and visually accessible format that allows users to monitor, analyze, and respond to control execution outcomes. This ensures that network administrators, security teams, compliance officers, or other stakeholders can efficiently interpret the control status, assess deviations, and take necessary actions when required. The process begins once the system determines the first status by comparing the first input characteristic to the first output characteristic and applying any standardization, normalization, or threshold-based evaluations defined in the first execution pattern. The system then formats the first status into a structured data model, incorporating metadata, such as timestamps, component identifiers, risk levels, and execution results to provide additional context.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for implementing control hub component layers by for monitoring controls and/or implementing control hub orchestration layers by for executing controls.
2. The method of the preceding embodiment, further comprising: receiving a first request to determine a first execution pattern across a computer network for a first control; in response to the first request, determining, at a control hub orchestration layer, a first execution pattern by: determining a first entry point to the computer network for the first control based on a first input characteristic for the first control; determining a first network component corresponding to the first input characteristic; determining a second input characteristic for the first control;
selecting a second network component from a plurality of network components based on the second network component corresponding to the second input characteristic; and determining a hierarchical execution pathway between the first network component and the second network component.
3. The method of any one of the preceding embodiments, wherein determining the first entry point to the computer network for the first control based on the first input characteristic for the first control further comprises: determining a plurality of network components activated by the first control; determining a plurality of input characteristics for the plurality of network components; and comparing the plurality of input characteristics to determine an order at which the first input characteristic and the second input characteristic are generated.
4. The method of any one of the preceding embodiments, wherein determining the first entry point to the computer network for the first control based on the first input characteristic for the first control further comprises: determining a plurality of network components activated by the first control; and inputting the plurality of network components into a first model to determine an order at which the first input characteristic and the second input characteristic are generated.
5. The method of any one of the preceding embodiments, wherein determining the hierarchical execution pathway between the first network component and the second network component further comprises: inputting the first input characteristic and the second input characteristic into a first model to determine an output indicating an order at which the input characteristics are generated; and using the output to determine a hierarchical execution pathway.
6. The method of any one of the preceding embodiments, wherein determining the first entry point to the computer network for the first control based on the first input characteristic for the first control further comprises: comparing a plurality of input characteristics for a plurality of network components activated by the first control to determine dependencies between the plurality of network components; and using the dependencies to determine the first entry point.
7. The method of any one of the preceding embodiments, wherein determining the hierarchical execution pathway for the first execution pattern further comprise: determining a first sub-execution pattern for the first execution pattern; and determining a second sub-execution pattern for the first execution pattern.
8. The method of any one of the preceding embodiments, wherein determining the hierarchical execution pathway between the first network component and the second network component further comprising: determining a data transformation between the first input characteristic and the second input characteristic; and determining the data transformation corresponds to the first network component.
9. The method of any one of the preceding embodiments, wherein determining the hierarchical execution pathway between the first network component and the second network component further comprising: determining a workflow for a first operation governed by the first control; and determining the workflow corresponds to the first input characteristic and the second input characteristic.
10. The method of any one of the preceding embodiments, wherein determining the first network component corresponds to the first input characteristic further comprises: determining a first function performed by the first network component; and determining that the first function corresponds to the first input characteristic.
11. The method of any one of the preceding embodiments, wherein determining the first network component corresponds to the first input characteristic further comprises: determining a first device class for the first network component; and determining that the first device class corresponds to the first input characteristic.
12. The method of any one of the preceding embodiments, wherein determining the first execution pattern further comprises:

determining a first exit point to the computer network for the first control based on a third input characteristic for the first control; and determining a third network routing component from the plurality of network components based on the third network routing component corresponding to the third input characteristic.
13. The method of any one of the preceding embodiments, further comprising: storing, by the control hub orchestration layer, the first execution pattern; and receiving, by a control hub component layer, a second request to use the first execution pattern.
14. The method of any one of the preceding embodiments, further comprising: determining, a first status for the first control, based on comparing a first output characteristic of the first network component to the first execution pattern; and generating for display, on a user interface, the first status.
15. The method of any one of the preceding embodiments, further comprising: receiving a second request to monitor the first control across a computer network; in response to the second request, retrieving the first execution pattern corresponding to the first control; and determining the first network component and the second network component corresponds to the first control based on the hierarchical execution pathway for the first execution pattern.
16. The method of any one of the preceding embodiments, further comprising: retrieving a first execution pattern corresponding to a first control, wherein the first execution pattern comprises a hierarchical execution pathway that is predetermined for the first control by a control hub orchestration layer; determining, at a control hub component layer, a first network component and a second network component corresponding to the first control based on the hierarchical execution pathway for the first execution pattern; retrieving a first input characteristic and a first input metric for the second network component; detecting a first output characteristic for the first network component; comparing, using the first input metric, the first input characteristic to the first output characteristic; determining, a first status for the first control, based on comparing the first input characteristic to the first output characteristic; and generating for display, on a user interface, the first status.
17. The method of any one of the preceding embodiments, wherein retrieving the first execution pattern corresponding to the first control further comprises; receiving a first request to implement a first operation across a computer network; and receiving a second request to monitor the first control across the computer network; and determining to retrieve the first execution pattern in response to the second request.
18. The method of any one of the preceding embodiments, wherein determining the first network component and the second network component corresponding to the first control based on the hierarchical execution pathway for the first execution pattern further comprises:
determining a workflow for implementing a first operation across a computer network; and
determining an order of network components used to implement the first operation based on the first execution pattern.
19. The method of any one of the preceding embodiments, wherein retrieving the first input characteristic and the first input metric for the second network component further comprises: determining a first value range of inputs for the second network component; and determining the first input characteristic based on the first value range.
20. The method of any one of the preceding embodiments, wherein retrieving the first input characteristic and the first input metric for the second network component further comprises: determining a unit of measure for values for the second network component; and determining the first input metric based on the unit of measure for values.
21. The method of any one of the preceding embodiments, wherein retrieving the first input characteristic and the first input metric for the second network component further comprises: determining a first threshold variation for inputs to the second network component; and determining the first input characteristic based on the first threshold variation.
22. The method of any one of the preceding embodiments, wherein retrieving the first input characteristic and the first input metric for the second network component further comprises: determining a first input type for the second network component; and determining the first input metric based on the first input type.
23. The method of any one of the preceding embodiments, wherein retrieving the first input characteristic and the first input metric for the second network component further comprises: determining a data source for the second network component; and determining the first input characteristic and the first input metric based on the data source.
24. The method of any one of the preceding embodiments, wherein retrieving the first input characteristic and the first input metric for the second network component further comprises: determining a data type used by the second network component; and determining the first input characteristic and the first input metric based on the data type.
25. The method of any one of the preceding embodiments, wherein determining, the first status for the first control, based on comparing the first input characteristic to the first output characteristic further comprises: retrieving a difference between the first input characteristic to the first output characteristic; and determining a normalization to apply to the difference based on the first execution pattern to determine the first status.
26. The method of any one of the preceding embodiments, wherein determining, the first status for the first control, based on comparing the first input characteristic to the first output characteristic further comprises: converting the first input characteristic and the second output characteristic into standardized values for the first execution pattern; and using the standardized values to determine the first status.
27. The method of any one of the preceding embodiments, wherein the first execution pattern is determined by: determining a first entry point to a computer network for the first control based on the first input characteristic for the first control; and determining that the first network component corresponds to the first input characteristic.
28. The method of any one of the preceding embodiments, wherein the first execution pattern is determined by: inputting the first input characteristic and the second input characteristic into a first model to determine an output indicating an order at which the first input characteristic and the second input characteristic are generated; and using the output to determine a hierarchical execution pathway.
29. The method of any one of the preceding embodiments, wherein the first execution pattern is determined by: determining a first sub-execution pattern for the first execution pattern; and determining a second sub-execution pattern for the first execution pattern.
30. One or more non-transitory, computer-readable mediums storing instructions that, when executed by a data processing apparatus, cause the data processing apparatus to perform operations comprising those of any of embodiments 1-29.
31. A system comprising one or more processors; and memory storing instructions that, when executed by the processors, cause the processors to effectuate operations comprising those of any of embodiments 1-29.
32. A system comprising means for performing any of embodiments 1-29.

What is claimed is:

1. A system for implementing control hub component layers for monitoring control execution in diverse network ecosystems, the system comprising:
one or more processors; and
an application-specific integrated circuit (ASIC) comprising instructions that, when executed by one or more processors, cause operations comprising:
receiving, at a control hub component layer in a first computer stack, a first request to monitor a first control across a computer network;
in response to the first request, at the control hub component layer, retrieving a first execution pattern corresponding to the first control, wherein the first execution pattern comprises a hierarchical execution pathway that is predetermined for the first control by a control hub orchestration layer in the first computer stack;
determining, at the control hub component layer, a first network routing component and a second network routing component corresponding to the first control based on the hierarchical execution pathway for the first execution pattern;
retrieving a first input characteristic and a first input metric for the second network routing component, wherein the first input characteristic indicates a first value range of inputs to the second network routing component, and wherein the first input metric comprises a first unit of measure for the first value range of inputs;
detecting a first output characteristic for the first network routing component, wherein the first output characteristic comprises a first value;
comparing, using the first input metric, the first input characteristic to the first output characteristic by comparing the first value to the first range of values;
determining, a first status for the first control, based on comparing the first input characteristic to the first output characteristic; and
generating for display, on a user interface, the first status.

2. A method for implementing control hub component layers by for monitoring controls across diverse network ecosystems, the method comprising:
retrieving a first execution pattern corresponding to a first control, wherein the first execution pattern comprises a hierarchical execution pathway that is predetermined for the first control by a control hub orchestration layer;
determining, at a control hub component layer, a first network component and a second network component corresponding to the first control based on the hierarchical execution pathway for the first execution pattern;
retrieving a first input characteristic and a first input metric for the second network component;
detecting a first output characteristic for the first network component;
comparing, using the first input metric, the first input characteristic to the first output characteristic;
determining, a first status for the first control, based on comparing the first input characteristic to the first output characteristic; and
generating for display, on a user interface, the first status.

3. The method of claim 2, wherein retrieving the first execution pattern corresponding to the first control further comprises;
receiving a first request to implement a first operation across a computer network;
receiving a second request to monitor the first control across the computer network; and
determining to retrieve the first execution pattern in response to the second request.

4. The method of claim 2, wherein determining the first network component and the second network component corresponding to the first control based on the hierarchical execution pathway for the first execution pattern further comprises:
determining a workflow for implementing a first operation across a computer network; and
determining an order of network components used to implement the first operation based on the first execution pattern.

5. The method of claim 2, wherein retrieving the first input characteristic and the first input metric for the second network component further comprises:
determining a first value range of inputs for the second network component; and
determining the first input characteristic based on the first value range.

6. The method of claim 2, wherein retrieving the first input characteristic and the first input metric for the second network component further comprises:
determining a unit of measure for values for the second network component; and
determining the first input metric based on the unit of measure for values.

7. The method of claim 2, wherein retrieving the first input characteristic and the first input metric for the second network component further comprises:
determining a first threshold variation for inputs to the second network component; and
determining the first input characteristic based on the first threshold variation.

8. The method of claim 2, wherein retrieving the first input characteristic and the first input metric for the second network component further comprises:
determining a first input type for the second network component; and
determining the first input metric based on the first input type.

9. The method of claim 2, wherein retrieving the first input characteristic and the first input metric for the second network component further comprises:
determining a data source for the second network component; and
determining the first input characteristic and the first input metric based on the data source.

10. The method of claim 2, wherein retrieving the first input characteristic and the first input metric for the second network component further comprises:
determining a data type used by the second network component; and
determining the first input characteristic and the first input metric based on the data type.

11. The method of claim 2, wherein determining, the first status for the first control, based on comparing the first input characteristic to the first output characteristic further comprises:
retrieving a difference between the first input characteristic to the first output characteristic; and
determining a normalization to apply to the difference based on the first execution pattern to determine the first status.

12. The method of claim 2, wherein determining, the first status for the first control, based on comparing the first input characteristic to the first output characteristic further comprises:
converting the first input characteristic and the second output characteristic into standardized values for the first execution pattern; and
using the standardized values to determine the first status.

13. The method of claim 2, wherein the first execution pattern is determined by:
determining a first entry point to a computer network for the first control based on the first input characteristic for the first control; and
determining that the first network component corresponds to the first input characteristic.

14. The method of claim 2, wherein the first execution pattern is determined by:
inputting the first input characteristic and the second input characteristic into a first model to determine an output indicating an order at which the first input characteristic and the second input characteristic are generated; and
using the output to determine a hierarchical execution pathway.

15. The method of claim 2, wherein the first execution pattern is determined by:
determining a first sub-execution pattern for the first execution pattern; and
determining a second sub-execution pattern for the first execution pattern.

16. One or more non-transitory, computer-readable media, comprising instructions that, when executed by one or more processors, cause operations comprising:
retrieving a first execution pattern corresponding to a first control;
determining a first network component and a second network component corresponding to the first control based on a hierarchical execution pathway for the first execution pattern;
in response to determining that the first network component and the second network component correspond to the first execution pattern:
retrieving a first input characteristic and a first input metric for the second network component;
detecting a first output characteristic for the first network component; and
determining, using the first input metric, a different between the first input characteristic to the first output characteristic;
determining, a first status for the first control, based on the difference; and
generating for display, on a user interface, the first status.

17. The one or more non-transitory, computer-readable media of claim 16, wherein retrieving the first input characteristic and the first input metric for the second network component further comprises:
determining a data source for the second network component; and
determining the first input characteristic and the first input metric based on the data source.

18. The one or more non-transitory, computer-readable media of claim 16, wherein retrieving the first input characteristic and the first input metric for the second network component further comprises:
determining a data type used by the second network component; and
determining the first input characteristic and the first input metric based on the data type.

19. The one or more non-transitory, computer-readable media of claim 16, wherein determining, the first status for the first control, based on comparing the first input characteristic to the first output characteristic further comprises:
retrieving a difference between the first input characteristic to the first output characteristic; and
determining a normalization to apply to the difference based on the first execution pattern to determine the first status.

20. The one or more non-transitory, computer-readable media of claim 16, wherein determining, the first status for the first control, based on comparing the first input characteristic to the first output characteristic further comprises:
converting the first input characteristic and the first output characteristic into standardized values for the first execution pattern; and
using the standardized values to determine the first status.
